(19) United States
(12) Patent Application Publication
(10) Pub. No.: US 2026/0313560 A1
(43) Pub. Date: Oct. 8, 2026

(54) SYSTEM AND METHOD FOR AN ADAPTIVE COMMUNICATION ENHANCEMENT SYSTEM WITH A RECONFIGURABLE METASURFACE AT AN INFORMATION HANDLING SYSTEM

(71) Applicant: Dell Products LP, Round Rock, TX (US)

(72) Inventors: Tejinder Singh, Manotick (CA); Navjot Kaur Khaira, Manotick (CA); Harpreet S. Narula, Austin, TX (US)

(73) Assignee: Dell Products LP, Round Rock, TX (US)

(21) Appl. No.: 19/169,502

(22) Filed: Apr. 3, 2025

(51) Int. Cl. H04W 52/24; H01Q 1/22; H01Q 15/00; H04B 7/06

(52) U.S. Cl. CPC H04W 52/241; H01Q 1/2258; H01Q 15/0086; H04B 7/0617

(57) ABSTRACT

A system and method of adaptively enhancing a communication system at a reconfigurable metasurface unit cell array operatively coupled to an information handling system. A reconfigurable metasurface unit cell array reflects incident radiofrequency signals transmitted or received by plural radiofrequency antennas on the information handling system and includes a plurality of reconfigurable metasurface unit cells each including a set of resonant structures to receive and reflect the incident radiofrequency signal. A metasurface controller may execute machine readable program code instructions of an adaptive communications enhancement system (ACES) module to determine when the radiofrequency signal falls below a sufficient radiofrequency signal communication threshold and adjust power to at least one antenna and adjust the reconfigurable metasurface unit cell array to beamform the radiofrequency signal to dynamically increase signal levels of the radiofrequency signal with a target wireless device in a radiofrequency environment or maintain configuration when signal levels are sufficient.

### FIELD OF THE DISCLOSURE

The present disclosure generally relates to an adaptive communication enhancement system (ACES) for wireless transmissions and reception at an information handling system. More specifically, the present disclosure relates to a reconfigurable metasurface unit cell array integrated into an information handling system, such as a laptop, which employs an adaptive communication enhancement system (ACES) to enhance signal quality and directivity among a plurality of wireless antennas, thus reducing overall power consumption.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system include one or more wireless interface adapters for operating wireless communications via one or more wireless protocols.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system with a metasurface controller executing machine readable code instructions for an adaptive communication enhancement system at a reconfigurable metasurface unit cell array formed on the information handling system according to an embodiment of the present disclosure;

FIG. 2 is a block and graphic diagram illustrating an information handling system with a metasurface controller executing machine readable code instructions for an adaptive communication enhancement system at a reconfigurable metasurface unit cell array formed on the information handling system according to an embodiment of the present disclosure;

FIG. 3 is block and graphic diagram of a reconfigurable metasurface unit cell array operatively coupled to a metasurface controller executing machine readable code instructions for a radiofrequency (RF) signal filtration and decision module and device activation and management system for an adaptive communication enhancement system according to an embodiment of the present disclosure;

FIG. 4A is a top view graphic diagram showing a reconfigurable metasurface unit cell array and an exploded perspective view graphic diagram showing a reconfigurable metasurface unit cell according to an embodiment of the present disclosure;

FIG. 4B is a side view graphic diagram showing a reconfigurable metasurface unit cell according to an embodiment of the present disclosure;

FIG. 5 is a swim lane diagram showing a method of executing machine readable code instructions for an adaptive communication enhancement system at a reconfigurable metasurface unit cell array formed on an information handling system according to an embodiment of the present disclosure; and

FIG. 6 is a flow diagram of a method of executing machine readable code instructions for an adaptive communication enhancement system at a reconfigurable metasurface unit cell array formed on an information handling system according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid data transmission and communication between multiple wireless devices. Wireless devices may include wirelessly enabled information handling systems, access point devices, or any computing device and may include various internet of things (IoT) devices that are wirelessly capable. As data transmission requirements increase, the electromagnetic (EM) wave (e.g., 5G technologies using 20 to 50 GHz wireless signals or other frequencies, or WiFi 6 signals at 2.4 GHz, 5 GHz or even 6 GHz) used to transmit these ever-increasing amounts of data are shortened or may benefit from extended range such as reach around radiofrequency barriers such as walls. However, the ability to penetrate walls and building structures as well as transmit around these relatively large structures may be limited with such wireless systems. Additionally, material properties of these buildings and other structures effect reflection and transmission of electromagnetic (EM) waves through building materials and on the absorption of EM wave energy in those materials, which gives rise to attenuation of the EM signal. Other EM wave-inhibiting mechanisms include diffraction from the edges of materials and scatter from rough edges also exist in radiofrequency environments such as rooms within a building. Further, most buildings behave as lossy dielectrics as building materials as well as occasionally conductive material that further inhibit or scatter EM wave propagation.

With the advent of massive multiple input multiple output (MIMO) wireless technologies as well as plural wireless protocols used with wireless devices, a group of antennas at both the transmitting device and receiving device may provide plural wirelessly capable wireless communication systems for high levels of available wireless bandwidth and wireless communication flexibility. However, with these high spectral transmitting and receiving devices such as 2.4, 5, and 6 GHz antennas, 5G-NR antennas, Bluetooth® antennas and other antennas on a wireless information handling system, electromagnetic field (EMF) interference as well as user exposure may be a concern. Additionally, power consumption becomes an additional concern when these multiple antennas are activated especially when idle antennas are not transceiving data. Modern information handling systems such as laptops may use power to continuously transceive wireless signals according to multiple protocols in order to maintain wireless connectivity to the internet or other wireless devices. This may lead to a significant level of unnecessary power consumption by the information handling system which may rely on battery power as well as potentially diminished wireless link connectivity quality of service for one or more wireless protocols especially with multiple wireless protocol antennas co-located on the same wireless information handling system. Additionally, there is no current wireless solution in laptop-type information handling systems that provide for dynamic adaptation to changing conditions and user needs relative to radiofrequency signal levels and ineffective power usage at the information handling system and including a reconfigurable metasurface unit cell array formed on the information handling system.

Current wireless solutions in laptops and other information handling systems often rely on fixed-power transmission and static antenna configurations that include predefined power settings or have limited adjustment of those wireless systems. These predefined power settings or limited adjustments to the same do not effectively adapt to changing signal conditions or user requirements, thereby leading to consistent power consumption waste regardless of the state of the wireless network and other wireless settings. Some laptops and other information handling systems may use basic power-saving techniques such as turning off unused radios or reducing transmission power levels. However, these power-saving techniques lack the ability to dynamically adjust transmission power and directionality and gain of EM waves (e.g., beamforming) based on real-time performance metrics such received signal strength indicator (RSSI), signal-to-noise ratio (SINR), and other system workload requirements via a reconfigurable metasurface unit cell array formed on the information handling system as described in embodiments of the present disclosure.

Still further, the user may be subjected to significant electromagnetic field (EMF) exposure when these radios are activated consistently. In an attempt to alleviate these issues, some manufacturers have created tech-shields such as laptop cases and phone covers that include EMF blocking materials like silver and aluminum. These shields can block or reduce radiation emitted from electronic devices, thereby minimizing exposure to body parts, especially when using devices close to the body. While effective to some extent, these shields do not offer any real-time adjustment or optimization based on environmental conditions or user needs. Further, these tech-shields may impact radiofrequency signal transmission or reception variably depending on conditions. There currently is no system that provides for real-time control of EMF levels to protect the user from EMF exposure.

The present specification describes a system and method of adaptively enhancing a communication system having a plurality of wireless antennas with a reconfigurable metasurface unit cell array formed on an information handling system. In an embodiment, the information handling system includes a hardware processor, a memory device, and a power management unit (PMU) to provide power to the hardware processor and memory device. The information handling system may also include a reconfigurable metasurface unit cell array operatively coupled to a chassis surface of the information handling system to manipulate electromagnetic (EM) waves of radiofrequency signals from the plurality of antennas operating on the information handling system as well as incident from a radiofrequency environment around the wireless information handling system. In embodiments of the present disclosure, the reconfigurable metasurface unit cell array includes a plurality of reconfigurable metasurface unit cells with each metasurface unit cell including a set of resonant structures with adjustable conductivity or capacitance among resonant structures for reconfigurable phase shift to reflected radiofrequency signals by those reconfigurable metasurface unit cells. In some embodiments, the resonant structures of the reconfigurable unit cells include a plurality of concentric metasurface reconfigurable split rings and other resonant structures to receive the incident radiofrequency signal, from onboard antennas or from the radiofrequency environment, to reflect and phase shift those incoming EM waves as directed by the metasurface controller to yield constructive or destructive interference among plural reconfigurable metasurface unit cells in a reconfigurable metasurface unit cell array formed on the information handling system. This constructive or destructive interference may be used to beamform particular radiofrequency signals for enhanced directionality and gain or to reduce levels of other radiofrequency signals according to embodiments herein. The information handling system may also include a plurality of radio frequency (RF) antennas formed around a perimeter of the reconfigurable metasurface unit cell array to transceive wireless network data with a wireless network for one or more wireless adapters of the wireless information handling system.

During operation, a metasurface controller may execute machine readable program code instructions of an adaptive communications enhancement system (ACES) module to determine when an actively used radiofrequency signal meets a sufficient radiofrequency signal communication threshold selected from a received signal strength indicator (RSSI) threshold level from an RSSI sensor and from a signal-to-interference-plus-noise ratio (SINR) threshold level from an SINR sensor. The metasurface controller may then execute machine readable program code instructions of a device activation and management module as part of the ACES module to determine, based on whether the RSSI threshold level or SINR threshold level has been reached, when power to any of the plurality of RF antennas should be adjusted and whether the metasurface is to be dynamically adjusted to dynamically adjust gain and direction of transmission and reception levels for one or more radiofrequency signals of the information handling system. Thus, in an embodiment, the reconfigurable metasurface unit cell array may be operatively coupled to the metasurface controller and PMU for power control of one or more antennas as well as the reconfigurable metasurface unit cell array such that the reconfigurable metasurface unit cell array may act as a power-saving radiofrequency signal beam steerable array to improve signal quality and directivity while also reducing power consumption.

In some embodiments, the reconfigurable metasurface unit cell array having one or more antennas may be operatively coupled to a chassis surface of the wireless information handling system. In an embodiment, the chassis surface may be a display chassis lid cover of the information handling system. In another embodiment, the back chassis surface of a tablet chassis for a tablet-type information handling system. Other chassis surfaces of an information handling systems may also have the reconfigurable metasurface unit cell array with one or more antennas operatively coupled to them in other embodiments.

Because the reconfigurable metasurface unit cell array is reconfigurable, the present specification contemplates any type of reconfigurable metasurface unit cell array. The use of reconfigurable resonant structures with some resonant structures including adjustable conductive or dielectric phase properties as described above are contemplated for some reconfigurable metasurface unit cells. In another embodiment, the metasurface controller may send a bias voltage to an attenuator circuit to adjust the amplitude of the reflected radiofrequency signal at a reconfigurable metasurface unit cells to adjust a level of constructive interference via resonant structures among plural reconfigurable metasurface unit cells to the incident radiofrequency signal created by phase adjustment operation of a tunable delay circuit of each reconfigurable metasurface unit cell. In an embodiment, the metasurface controller may send a bias voltage to a tunable delay circuit to phase shift the captured, incident radiofrequency signal to generate a reflected radiofrequency signal lobe among plural adjacent reconfigurable metasurface unit cells for interference patterns in the incoming EM waves of the incident radiofrequency signal. Thus, the reconfigurable metasurface unit cell array creates directional EM wave radiofrequency transmission or reception lobes with an associated signal gain within the reflected EM waves of the incident radiofrequency signal. In an embodiment, the reconfigurable metasurface unit cell array may include a signal matching circuit operatively coupled to each of the microwave circuits of the plurality of reconfigurable metasurface unit cells to match the impedance received from each of a plurality of microwave circuits prior to feeding the captured, incident radiofrequency signal to a tunable delay circuit for phase shifting. In another embodiment, the metasurface controller may send a bias voltage to a tunable delay circuit to phase shift the captured, incident radiofrequency signal at each reconfigurable metasurface unit cell to generate a reflected radiofrequency signals among the plural metasurface unit cells to create a null region interference pattern in the reflected incident radiofrequency signal to create reduced EM waves on a particular side of the information handling system.

The reconfigurable metasurface unit cell array, as controlled by execution of machine readable code instructions of the ACES module, operates to engage in beamforming using constructive and/or destructive phase shifted interference patterns of reflected EM waves while allowing for reducing power consumption to achieve threshold RSSI or SINR levels in embodiments herein. Further, the execution of machine readable code instructions of the ACES module may also operate to engage in beamforming using constructive and/or destructive phase shifted interference patterns of reflected EM waves to knock down or reduce EM wave levels in selected directions around the wireless information handling system to protect a user from EMF exposure in other embodiments. Additionally, the metasurface controller executing of machine readable code instructions of the ACES module operates to provide more power to the plurality of RF antennas in order to maintain sufficient wireless connection and coverage for active wireless radiofrequency signals within the radiofrequency environment, based on detected RSSI and SINR values among other wireless network characteristics in other embodiments herein.

Thus, the presently-described reconfigurable metasurface unit cell array of embodiments herein is real-time configurable such that the reconfigurable metasurface unit cell array can selectively create directional lobes with enhanced gain of radiofrequency signals to engage in power saving techniques to reduce power consumption required by one or more wireless antennas operating at a wireless information handling system. Additionally, unlike systems that use passive antenna control of power levels and fixed directionality, the presently described system and method incorporates an adaptive reconfigurable metasurface unit cell array that selectively steers and enhances signal directionality and strength originating from the antennas on a wireless information handling system in real-time. The inclusion of the adaptive attenuator circuit provides for the management of signal strength with the system described in some embodiments herein being capable of gradually adjusting the attenuator circuit and tunable delay circuits of some types of reconfigurable metasurface unit cells based on real-time bandwidth requirements and real-time wireless signal conditions at the wireless information handling system.

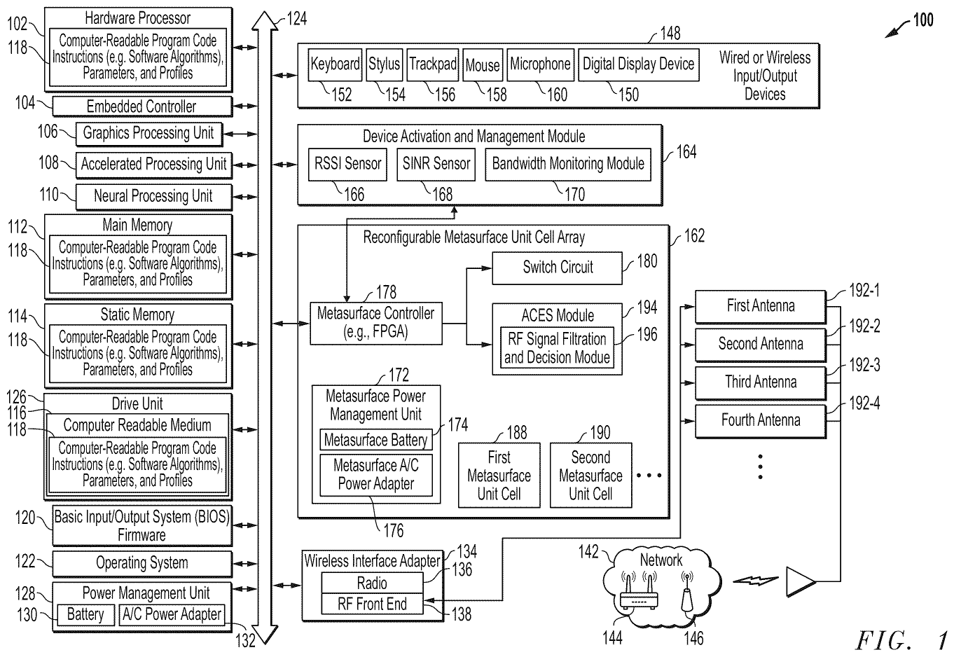

Turning now to the figures, FIG. 1 illustrates an information handling system 100 similar to the information handling systems according to several aspects of the present disclosure that may operate as a source or target radiofrequency device for use with the reconfigurable metasurfaces of the embodiments of the present disclosure. It is appreciated that terms such as “reconfigurable metasurface unit cell array” or “reconfigurable metasurface unit cell array” are meant to be understood as a metasurface that includes a plurality of reconfigurable unit cells that operate together to engage in, at least, reflecting, beamforming, and transmission of EM waves. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Machine readable program code instructions stored in static memory 114, main memory 112, or drive unit 126 may be involved in invoking such machine readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine readable program code instructions (e.g., software algorithms) parameters, and profiles 118 that may operate on servers or systems, remote data centers, or on-box in individual client information handling systems according to various embodiments herein. In some embodiments, it is understood that any or all portions of machine readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing machine readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device or wireless interface adapter 134 with its radio 136, RF front end 138 and one or more antennas 192-1, 192-2, 192-3, 192-4 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems. In the context of the present disclosure the one or more antennas 192-1, 192-2, 192-3, 192-4 may include one or more WiFi antennas operating at 2.4 GHz, 5 GHz, and/or 6 GHz frequencies, one or more Bluetooth antennas, and one or more 5G new radio (5G-NR) antennas that operate at Frequency Range 1 (FR1) (which includes sub-7 GHz frequency bands and those from 410 MHz to 7125 MHz 0 and Frequency Range 2 (FR2) (which includes frequency bands from 24.25 GHz to 71.0 GHz frequency bands). It is appreciated that the one or more antennas 192-1, 192-2, 192-3, 192-4 may support any frequency or frequency range and the present specification appreciates the use of these other types of antennas 192-1, 192-2, 192-3, 192-4 to be formed on a periphery of the reconfigurable metasurface unit cell array 162. In some embodiments herein, plural wireless interface devices or wireless interface adapters 134 may utilize plural radios 136, RF front ends 138 for each type of radio protocol used with the one or more antennas 192-1, 192-2, 192-3, 192-4. In other embodiments herein, a single wireless interface device or wireless interface adapter 134 may utilize a radio 136 and RF front end 138 for plural of the radio protocols used with the one or more antennas 192-1, 192-2, 192-3, 192-4.

In other embodiments, the wireless interface device 134 with its radio 136, RF front end 138 and antennas 192-1, 192-2, 192-3, 192-4 are used to communicate with a WWAN or and WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 192-1, 192-2, 192-3, 192-4 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via the reconfigurable metasurface unit cell array 162. The receiver device 178 may be any other device and may include the AP 144, the base station 146, or any other computing device described herein. Additionally, the information handling system 100 and receiver device 178 may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of reflecting these types of mm waves to relay radiofrequency signals with directionality or to generate null regions of low EMF in various embodiments herein.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes machine readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a machine readable medium that includes machine readable program code instructions, parameters, and profiles 118 or receives and executes machine readable program code instructions, parameters, and profiles 118 responsive to a propagated signal, so that a hardware device connected to a network 142 may communicate voice, video, or data over the network 142. Further, the machine readable program code instructions, parameters, and profiles 118 may be transmitted or received over the network 142 via the network interface device or wireless interface adapter 134.

The information handling system 100 may include a set of machine readable program code instructions, parameters, and profiles 118 that may be executed to cause the computer system to perform any one or more of the methods or computer-based functions disclosed herein. For example, machine readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a machine readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain machine readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain machine readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the machine readable medium is shown to be a single medium, the term “machine readable medium” includes a single medium or multiple media, such as a centralized or distributed database, and/or associated caches and servers that store one or more sets of machine-readable code instructions. The term “machine readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the machine readable medium can include a solid-state memory such as a memory card or other package that houses one or more non-volatile read-only memories. Further, the machine readable medium can be a random-access memory or other volatile re-writable memory. Additionally, the machine readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a machine readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may include a reconfigurable metasurface unit cell array 162. In an embodiment, the reconfigurable metasurface unit cell array 162 may be affixed to a display chassis cover of the laptop-type information handling system 100 such as the A-cover of a laptop type information handling system or the back of a tablet type information handling system. The A-cover may include a top portion of the lid of the laptop-type information handling system 100 housing an integrated digital display device 150, for example. The placement of the reconfigurable metasurface unit cell array 162 on the A-cover of the laptop-type information handling system 100 or the back of a tablet-type information handling system 100 may allow those electromagnetic fields (EMFs) generated by the EM waves that are received and transmitted by the one or more antennas 192-1, 192-2, 192-3, 192-4 to be controlled via directed reflection or formation of null regions. Additionally, the reconfigurable metasurface unit cell array 162 may enhance communication using a metasurface controller executing machine readable code instructions of an adaptive communications enhancement system (ACES) module 194 as described in embodiments herein. The reconfigurable metasurface unit cell array 162 may be used to create directional lobes of EM waves to increase gain of radiofrequency signals in a particular direction in some embodiments, thus allowing greater RSSI or lower SINR on transmitted or received radiofrequency signals without additional increase power supplied to antennas 192-1, 192-2, 192-3, 192-4 or others in embodiments herein. As described in some embodiments herein, the reconfigurable metasurface unit cell array 162 may also be used to create a null region within the generated EMFs at or around the user and adaptively minimize power usage to reduce EMF exposure from the one or more antennas 192-1, 192-2, 192-3, 192-4 or from radiofrequency signals received or reflected by the radiofrequency environment.

The reconfigurable metasurface unit cell array 162 may, in an embodiment, include a metasurface power management unit (PMU) 172. The metasurface PMU 172 may be a power source used to power the devices, circuits, and elements operatively coupled to and/or formed onto the reconfigurable metasurface unit cell array 162. In an embodiment, the metasurface PMU 172 may include a metasurface battery 174 that is used by the metasurface PMU 172 to power, with low power, those devices. Alternatively, and in another embodiment, the metasurface PMU 172 may include a metasurface A/C power adapter 176 that regulates power received from an A/C power source such as that of the information handling system 100. Again, the reconfigurable metasurface unit cell array 162 including the devices, circuits, and elements operatively coupled to and/or formed onto the reconfigurable metasurface unit cell array 162 require low power for operation according to some embodiments herein. In this embodiment, the metasurface PMU 172 may be operatively coupled to the PMU 128 of the information handling system 100 such that the PMU 128 and metasurface PMU 172 operate together to provide power to those devices associated with the reconfigurable metasurface unit cell array 162 as described herein.

In an embodiment, the reconfigurable metasurface unit cell array 162 includes a plurality of addressable reconfigurable metasurface unit cells 188, 190 shown in FIG. 1 to include, at least, a first metasurface unit cell 188 and a second metasurface unit cell 190. It is appreciated, however, that the reconfigurable metasurface unit cell array 162 may include more than the first metasurface unit cell 188 and second metasurface unit cell 190 shown in FIG. 1. In an embodiment, the reconfigurable metasurface unit cell array 162 may include an array of addressable reconfigurable metasurface unit cells 188, 190 arranged in rows and columns that may include nine by nine array of unit cells. It is appreciated, however, that any arrangement and any number of reconfigurable metasurface unit cells 188, 190 may be used to form the reconfigurable metasurface unit cell array 162 described herein. In an embodiment, a plurality of reconfigurable metasurface unit cells 188, 190 may form a subgroup of unit cells with the reconfigurable metasurface unit cell array 162 including a plurality of subgroups of reconfigurable metasurface unit cells 188, 190. In an embodiment, each subgroup of unit cells may include nine reconfigurable metasurface unit cells 188, 190 with each subgroup of unit cells being operatively coupled to a metasurface controller 178 that controls the operation of each of the subgroups of reconfigurable metasurface unit cells 188, 190 and, in an embodiment, each reconfigurable metasurface unit cell 188, 190 individually.

In an embodiment, each addressable reconfigurable metasurface unit cell 188, 190 may be operatively controlled by the metasurface controller 178. In order to control the operation of each of the reconfigurable metasurface unit cells 188, 190 and/or a subgroup of reconfigurable metasurface unit cells 188, 190 within the reconfigurable metasurface unit cell array 162, the metasurface controller 178 may control the operation of a switch circuit 180, and any adjustable components such as one or more attenuator circuits (not shown), or one or more tunable delay circuits 186 of reconfigurable metasurface unit cells 188, 190 or addressable phase-change material resonant structures of the reconfigurable metasurface unit cells 188, 190 in various embodiments. The metasurface controller 178 may execute machine readable code instructions of an adaptive communication enhancement system (ACES) module 194 operating with switching of power from the metasurface PMU 172 to generate controlling pulses or power to one or more addressable reconfigurable metasurface unit cells 188, 190 in the reconfigurable metasurface unit cell array 162 in embodiments herein. For ease of understanding, the operation of the metasurface controller 178, switch circuit 180, power combiner circuit 182, attenuator circuit 184, and tunable delay circuit 186 will be described as controlling a single subgroup of reconfigurable metasurface unit cells 188, 190 within the reconfigurable metasurface unit cell array 162. It is appreciated, however, that the metasurface controller 178, via the operation of the switch circuit 180 and power combiner circuit 182 and via execution of machine readable code instructions of the ACES module 194, may control the operation of a single attenuator circuit or tunable delay circuit 186 for each of the reconfigurable metasurface unit cells 188, 190 among a plurality of subgroups of reconfigurable metasurface unit cells 188, 190 within the reconfigurable metasurface unit cell array 162 in various embodiments.

Each of the reconfigurable metasurface unit cells 188, 190 may include a set of resonant structures formed on a substrate that receive incident EM waves and reflect those incident EM waves propagated omnidirectionally from one or more of the antennas 192-1, 192-2, 192-3, 192-4 formed on a periphery of reconfigurable metasurface unit cell array 162 or nearby the reconfigurable metasurface unit cell array 162 or even incident EM waves received from the radiofrequency environment. In one example embodiment, the resonant structures formed on the substrate of the reconfigurable metasurface unit cells 188, 190 may include a conductive ring concentric with circular phase change material metasurface reconfigurable split rings and a conductive center node such that phase changing the concentric circular metasurface reconfigurable split rings may alter the phase shifting of incident EM waves. While concentric circular metasurface reconfigurable split rings are discussed in embodiments herein, any shape of conductive outer ring concentric with metasurface reconfigurable split rings for the metasurface unit cell 188, 190 may be used. These concentric circular metasurface reconfigurable split rings of the reconfigurable metasurface unit cells 188, 190 of the example embodiment may receive those incident EM waves and resonate at a specific frequency for particular radiofrequency signals that will be incident upon the reconfigurable metasurface unit cells 188, 190. The size of the resonant structures or gaps therebetween and of the reconfigurable metasurface unit cells 188, 190 may determine the particular radiofrequency signals that may be reflected for direction or adjusted for null regions in embodiments herein. In an embodiment, the metasurface controller 178 may manipulate the individual reconfigurable metasurface unit cells 188, 190 such that incident EM wave energy may be phase shifted across plural reconfigurable metasurface unit cells 188, 190 to be reflected or beamformed in a certain direction. With the concentric circular metasurface reconfigurable split rings receiving input signals to address and change a phase change material of the phase change material split rings, the metasurface controller may control the EM phase shift of reconfigurable metasurface unit cells 188, 190 and thus directionality of the reflected EM wave is beamformed with constructive or destructive interference across plural reconfigurable metasurface unit cells 188, 190.

The reconfigurable metasurface unit cells 188, 190 may be addressed to change resonant structures as described above to adjust phase shift of reflected EM waves for beamforming across the plurality of reconfigurable metasurface unit cells 188, 190 in embodiments such as above. In other embodiments, the addressable reconfigurable metasurface unit cells 188, 190 may be adjusted from the operation of the tunable delay circuit 186 that may be tuned such that troughs and peaks of one reflected EM signal of one reconfigurable metasurface unit cell aligns or are otherwise shifted to align with troughs and peaks of another reflected EM wave of the RF signal at adjacent reconfigurable metasurface unit cells 188, 190, such that the incident RF signal is thereby constructively increased forming a direction lobe of the EM wave energy. This directional lobe with increased gain of the reflected EM waves for an RF signal, in an embodiment, may be created towards a location at or from the laptop-type information handling system 100 where the antennas 192-1, 192-2, 192-3, 192-4 are formed for received RF signals or towards receiver wireless devices receiving RF signal transmissions from the information handling system 100. Amplitude control by the attenuator circuit ensures that the signals have similar magnitudes thereby enhancing the gain effect if needed. It is appreciated that the constructive interference techniques are employed such that the phase and amplitude adjustments by the tunable delay circuit 186 and attenuator circuit, respectively, may strengthen the emitted and reflected EM signals or received EM signals to extend the EM radiofrequency signal directional lobes for effective transmission or reflection of radiofrequency signals. These EM radiofrequency signal lobes may be beamformed towards a receiving device such as an AP 144 or base station 146 or another wireless information handling system for better transmission.

In order to dynamically enhance the communication of the various antennas 192-1, 192-2, 192-3, 192-4, the reconfigurable metasurface unit cell array 162 may include the machine readable code instructions of the adaptive communication enhancement system (ACES) module 194 executed by a metasurface controller 178 that interfaces with a device activation and management module 164 executed by a hardware processor 102 of the information handling system 100 in some embodiments. Execution of machine readable code instructions for the ACES module 194 by the metasurface controller 178 causes the metasurface controller 178 to communicate and request, at least, current RSSI data and SINR data from a RSSI sensor 166 and SINR sensor 168, respectively, that may operate on a wireless interface adapter 134 via its radio 136 and one or more of the plural antennas 192-1, 192-2, 192-2, or 192-4 to measure RSSI or SINR for radiofrequency signals. In various embodiments, one or more wireless interface adapters 134 may operate for the plural antennas 192-1, 192-2, 192-2, or 192-4 on the information handling system 100 or one or more wireless interface adapters 134 may be situated on a panel for the reconfigurable metasurface unit cell array 162. In an embodiment, the device activation and management module 164 may provide real-time RSSI and SINR data to the metasurface controller 178 for use by the ACES module 194 as described herein. In an embodiment, execution of the machine readable program code instructions of the ACES module 194 cause the ACES module 194 to evaluate a current communication environment within the wireless networks for various transmitted or received radiofrequency signals as well as workload and throughput data from the bandwidth monitoring module 170. Based on this data (e.g., RSSI data, SINR data, and workload and throughput data), the metasurface controller 178 may dynamically adjust transception power level related to each of the plurality of antennas 192-1, 192-2, 192-3, 192-4 and/or selectively deactivating non-essential antennas 192-1, 192-2, 192-3, 192-4 in order to save power. Additionally, with this data, the metasurface controller 178 may address the reconfigurable metasurface unit cell array 162 in order to enhance signal quality via, for example, beamforming those incident radiofrequency (RF) signals incident to the surface of the reconfigurable metasurface unit cell array 162 within the radiofrequency environment for particular radiofrequency (RF) signals including those RF signals transmitted from or received by any of the plurality of antennas 192-1, 192-2, 192-3, 192-4.

In an embodiment, the metasurface controller 178 may interface with an RF signal filtration module and decision module 196 as part of the ACES module 194 executing via the metasurface controller 178. Execution of the machine readable program code instructions of the RF signal filtration and decision module 196 may provide, as output, data related to how power to each of the antennas 192-1, 192-2, 192-3, 192-4 and the reconfigurable metasurface unit cell array 162 is to be altered in order to concurrently adjust transmitted, received, and reflected EM waves of radiofrequency signals while engaging in power saving processes described herein. Further, the plural antennas 192-1, 192-2, 192-2, or 192-4 and the reconfigurable metasurface unit cell array 162 may be adjusted to provide for or eliminate null regions for control of EMF exposure by a user of the information handling system 100 in other embodiments.

In order to reduce the EMF exposure to a user, the metasurface controller 178 may create a null region within an EM field using similar destructive and/or constructive interference across plural reconfigurable metasurface unit cells 188, 190 at the reconfigurable metasurface unit cell array 162 to generate null regions of EM waves in particular directions (e.g., towards an expected user's position) instead of directional lobes in embodiments herein. In an example embodiment, when the EM waves incident from the antennas 192-1, 192-2, 192-3, 192-4, or the wireless RF environment in some embodiments, on the reconfigurable metasurface unit cells 188, 190 of the reconfigurable metasurface unit cell array 162, the phase alignment and shift of the EM waves incident and reflected may form destructive (or even some constructive) interference patterns causing directed null regions. The reconfigurable metasurface unit cells 188, 190 may be addressed to change resonant structures to adjust phase shift of reflected EM waves or may be adjusted from the operation of the tunable delay circuit 186 may be tuned such that troughs of one signal align or are otherwise shifted to align with peaks of another signal of the incident RF signal from adjacent or nearby reconfigurable metasurface unit cells 188, 190, thereby cancelling the EM wave energy and creating the null region. This null region, in an embodiment, may be created at a location around the laptop-type information handling system 100 where the user will be interacting with the information handling system 100 such as in front of the keyboard 152 or a digital display device 150. Amplitude control by the attenuator circuit ensures that the signals have equal but opposite magnitudes thereby enhancing the cancellation effect if needed. It is appreciated that the constructive interference techniques may also be employed such that, outside the null region direction created, the phase and amplitude adjustments by the tunable delay circuit 186 and any attenuator circuit, respectively, may strengthen the emitted and reflected EM signals and extending the EM radiofrequency signal directional lobes in other directions for effective transmission or reflection of radiofrequency signals. These EM radiofrequency signal lobes may be beamformed towards a receiving device such as an AP 144 or base station 146 or another wireless information handling system for better transmission.

During operation, the information handling system 100 may operate the reconfigurable metasurface unit cell array 162 in a plurality of modes or states or combination of modes or states. A first state may include an EMF mitigation and power saving mode where the reconfigurable metasurface unit cell array 162 operates to limit operation of the one or more antennas 192-1, 192-2, 192-3, 192-4 while also activating the reconfigurable metasurface unit cell array 162 to create EMF null regions in directions of expected user presence. This may be done by the hardware processor 102 of the information handling system 100 providing instructions to a metasurface controller 178 of the reconfigurable metasurface unit cell array 162. A second mode may include a signal enhancement mode where, when bandwidth requirements call for increases in radiofrequency signal transmission or reception, this results in the hardware processor 102 of the information handling system 100 reducing the effects of the attenuation circuit for one or more antennas 192-1, 192-2, 192-3, 192-4 and adjusting the phase shifting of the EM waves by the reconfigurable metasurface unit cells 188, 190 such that transmitted EM waves for the radiofrequency signals are enhanced or increased. Execution of machine readable code instructions of the ACES module 194 may provide output to the wireless adapter 134 or hardware processor 102 of the information handing system 100 indicating that the antennas 192-1, 192-2, 192-3, 192-4 should be activated or remain active due to data transception throughput increases for one or more RF signals for one or more radiofrequency protocols.

During operation, the hardware processor 102 may execute machine readable program code of a device activation and management module 164. The device activation and management module 164 may interface with an RSSI sensor 166, an SINR sensor 168 operating at a wireless interface adapter 134, and, in an embodiment, a bandwidth monitoring module 170 monitoring data throughput from wireless communications to determine whether to operate the reconfigurable metasurface unit cell array 162 in an EMF mitigation and power saving mode or a signal enhancement mode in some embodiments. The hardware processor 102 executing machine readable code instructions of the device management module 164 may also direct enhanced power at one or more antennas 192-1, 192-2, 192-3 or 192-4 via the wireless interface adapter as well. reconfigurable metasurface unit cells 188, 190

For example, the device activation and management module 164 may interface with the RSSI sensor 166 at the wireless interface adapter 134 and its radio 136 to gather RSSI data from one or more one or more antennas 192-1, 192-2, 192-3 or 192-4. This RSSI sensor 166 detects the radiofrequency signal environment at and around the information handling system 100 by measuring the strength of the EM signals received at the information handling system 100. Similar RSSI data may be received from receiving wireless devices in a radiofrequency environment that receive radiofrequency transmissions from one or more antennas 192-1, 192-2, 192-3 or 192-4 of the information handling system. This may be expressed in terms of decibels (dBm). In an embodiment, the RSSI sensor 166 may continuously sense the dBm levels of EM signals at the information handling system or may be operated to occasionally monitor these dBm levels. Further, transmission dBm levels of transmitted RF signals may be continuously reported with wirelessly coupled receiver devices in a radiofrequency environment. The RSSI sensor 166 supplies or reported real-time RSSI data is supplied to the hardware processor 102 with dBm levels with the hardware processor 102 to compare current dBm levels to a baseline dBm level to determine if a threshold dBm level has been exceeded such that sufficient signal strength of RF signals are available to conduct wireless communication on those RF signals. This may further indicate that EMF can be mitigated via operation of the reconfigurable metasurface unit cell array 162 as well as indicate whether a power saving mode can be entered.

The SINR sensor 168 provides detailed feedback SINR data about the quality of the wireless signals being received and their susceptibility to interference and noise. SINR data may also be reported from wireless receiver devices in a radiofrequency environment. In an embodiment, the SINR sensor 168 evaluates the quality of wireless RF signals emitted or received by the antennas 192-1, 192-2, 192-3, 192-4 of the information handling system 100 or received from external sources relative to noise levels. The SINR data from the SINR sensor 168 or reported from wireless device in the radiofrequency environment may help to determine whether the signal-to-noise conditions are sufficient for reliable communication between the information handling system 100 and other receiving/transmitting devices within the environment. As described herein, the data received by the hardware processor 102 from the RSSI sensor 166 and SINR sensor 168 or as reported from the radiofrequency environment helps to determine whether power should be increased, reduced or turned off for any individual antenna 192-1, 192-2, 192-3, 192-4. Further, according to embodiments herein, the data received by the hardware processor 102 from the RSSI sensor 166 and SINR sensor 168 or as reported from the radiofrequency environment helps to determine when the reconfigurable metasurface unit cell array 162 is to be adjusted to engage in beamforming for particular RF signals or directionality or when a null region should be created or adjusted at the information handling system 100 via execution of machine readable code instructions of the ACES module 194.

In an embodiment, machine readable program code instructions of a bandwidth monitoring module 170 may also be executed by the hardware processor 102. The bandwidth monitoring module 170 may assess current and real-time bandwidth requirements of the information handling system 100 to ensure that wireless communication via the antennas 192-1, 192-2, 192-3, 192-4 meets the user's needs while conserving power and minimizing unnecessary EM wave emissions when available. For example, the user may execute machine readable program code of an online gaming or video streaming software application. In so doing, the bandwidth requirements at the information handling system 100 may increase such that creation of the null region and powering down or turning off of any of the antennas 192-1, 192-2, 192-3, 192-4 may prevent an increase in bandwidth capacity needed at the information handling system 100. As such, the hardware processor 102, detecting an increase in bandwidth requirements via operation of the bandwidth monitoring module 170, may interact with the metasurface controller 178 to decrease the size of the null region created or eliminate the null region so that higher amounts of data may be transmitted while also providing power to the one or more antennas 192-1, 192-2, 192-3, 192-4 for data transception. Further, directional lobes may be created via the reconfigurable metasurface unit cell array 162 for enhanced gain of radiofrequency signals transceived at the antennas 192-1, 192-2, 192-3, 192-4 with one or more wireless devices wirelessly coupled to the information handling system 100 in a radiofrequency environment. As described herein, this may be done at the reconfigurable metasurface unit cell array 162 with the metasurface controller 178 executing machine readable code instructions of ACES module 178 and RF signal filtration and decision module 196 to control the appropriate elements of the addressable reconfigurable metasurface unit cells 188, 190 of the reconfigurable metasurface unit cell array 162. The metasurface controller 178 may determine directional lobes while also reducing any null region or eliminate it while transmitting instructions to the hardware processor 102 and wireless interface adapter 134 to power up to operate, or even increase power at, the one or more antennas 192-1, 192-2, 192-3, 192-4. However, where the bandwidth requirements do not exceed a bandwidth threshold requirements, the hardware processor 102 may direct the metasurface controller 178 to maintain a level of power to the one or more antennas 192-1, 192-2, 192-3, 192-4 while continuing with the configuration of the reconfigurable metasurface unit cell array 162 or to create the null region with the reconfigurable metasurface unit cell array 162 for EMF mitigation as described herein.

During operation of the device activation and management module 164, the hardware processor 102 transmit current EM environment data from the RSSI sensor 166, SINR sensor 168, and bandwidth monitoring module 170 or reported RSSI data SINR data or bandwidth throughput data from other wireless devices in the radiofrequency environment to the metasurface controller 178. The metasurface controller 178, based on that data, may execute machine readable code instructions of the ACES module 194 to adjust the reconfigurable metasurface unit cell array 162 for signal enhancement or maintain current configuration in an embodiment. The metasurface controller 178, based on that data, may execute machine readable code instructions of the ACES module 194 to place the reconfigurable metasurface unit cell array 162 in either of the EMF mitigation and power saving mode or the signal enhancement mode as described in other embodiments herein. In order to switch between these two modes, the metasurface controller 178 may operate a switch circuit 180 that switches between control of the reconfigurable metasurface unit cell array 162 to control of the one or more antennas 192-1, 192-2, 192-3 or 192-4 that may be disposed on the panel of the reconfigurable metasurface unit cell array 162 in embodiments herein.

Thus, the presently-described reconfigurable metasurface unit cell array 162 of embodiments herein is real-time configurable such that the reconfigurable metasurface unit cell array 162 can selectively beamform RF signal to enhance gain of those RF signals without additional power, or even reduced power, to the antennas 192-1, 192-2, 192-3, 192-4 to optimize power usage in some embodiments. Further, reconfigurable metasurface unit cell array 162 of embodiments herein is real-time configurable to selectively create or adjust levels of null regions reducing EMF exposure from the antennas 192-1, 192-2, 192-3, 192-4 with reconfigurable metasurface unit cell array 162 depending on RF signal levels and quality. The metasurface controller 178 may execute machine readable code instructions of the ACES module 194 to dynamically adjust the phase shift of addressable reconfigurable metasurface unit cells 188, 190 of the reconfigurable metasurface unit cell array 162 thereby creating directional EM wave transmission lobe regions to enhance radiofrequency signal communications to or from the information handling system 100 to improve certain aspects of radiofrequency signal wireless operation of the information handling system 100 while limiting increases of power required at antennas 192-1, 192-2, 192-3, 192-4 in some embodiments. The methods and systems described herein using the reconfigurable metasurface unit cell array 162 also may dynamically adjust the phase shift for reconfigurable metasurface unit cells 188, 190 of the reconfigurable metasurface unit cell array 162 via execution of machine readable code instructions of the ACES module 194 thereby creating both these directional lobes or the null regions to minimize EMF exposure while also reducing or limiting the power consumed during RF signal transception.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

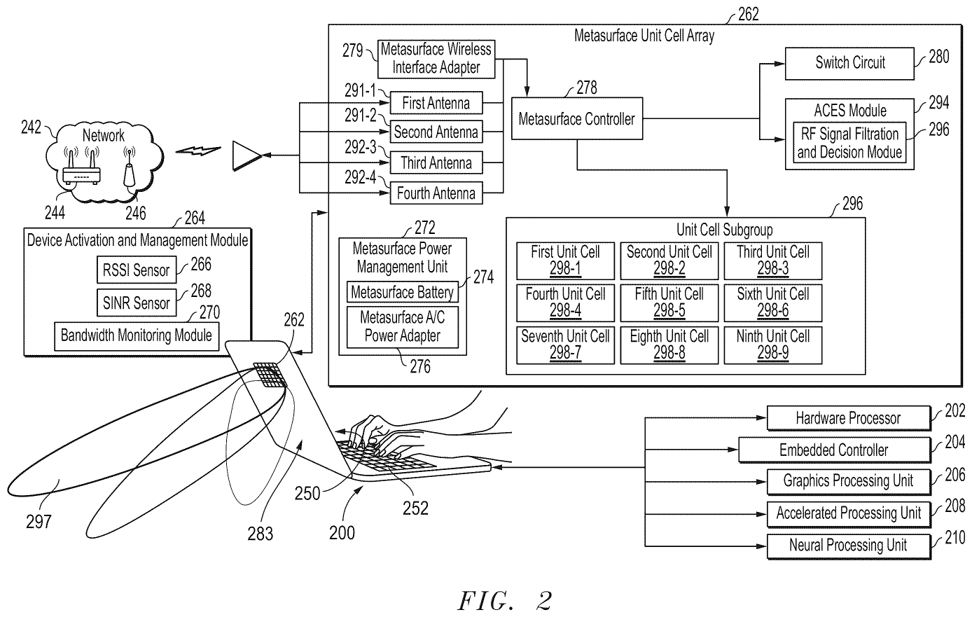

FIG. 2 is a block and graphic diagram illustrating an information handling system having a reconfigurable metasurface unit cell array comprising a plurality of addressable reconfigurable metasurface unit cells operatively coupled to the information handling system 200 according to an embodiment of the present disclosure. FIG. 2 shows the information handling system 200 as a laptop-type information handling system 200 that may include a digital display device 250 and a keyboard 252 as an output and input device, respectively. The information handling system 200 may be similar to the information handling system 100 of FIG. 1 and may include a hardware processor 202, embedded controller 204, graphics processing unit 206, accelerated processing unit 208, or neural processing unit 210 among other hardware processing devices according to embodiments herein. The laptop-type information handling system 200 may have the reconfigurable metasurface unit cell array 262 operatively coupled to the information handling system 200 on a surface of the display chassis lid portion or A-cover 283 of the information handling system 200 as in the shown embodiment or on another chassis portion of the information handling system 200. In an embodiment, the reconfigurable metasurface unit cell array 262 on the information handling system 200 may be operatively coupled to a metasurface controller 278 (e.g., a microcontroller unit and/or a field programmable gate array) via a hardware connection such as a wired connection passing through the a-cover 283. In an embodiment, the PMU (e.g., 128, FIG. 1) of the information handling system 200 may provide power to the reconfigurable metasurface unit cell array 262. In other embodiments, the reconfigurable metasurface unit cell array 262 may have a metasurface PMU (e.g., 172, FIG. 1) and a separate power source powering it.

As described herein, the information handling system 200 includes a reconfigurable metasurface unit cell array 262. In an embodiment, the reconfigurable metasurface unit cell array 262 which may be affixed to or installed on a cover of the information handling system 200 such as the A-cover 283 of the laptop-type information handling system 200 shown. The A-cover 283 represents the top portion of the display chassis lid of the information handling system 200. By placing the reconfigurable metasurface unit cell array 262 on the A-cover 283, electromagnetic (EM) waves transmitted and received by antennas 292-1, 292-2, 292-3, and 292-4 can be controlled via, at least, the creation of directional lobes 297 of reflected EM waves of radiofrequency signals in a radiofrequency environment 242 to other receiver/transmitter wireless devices such as an access point 246 or base station 244 in various embodiments herein and depending on radiofrequency environment conditions and bandwidth needs. Further, control over EMF levels of the EM waves transmitted and received by antennas 292-1, 292-2, 292-3, and 292-4 can be controlled by creation of a null region at or around the user thereby causing EMFs to be directed away from the surface of the A-cover 283 via operation of the reconfigurable metasurface unit cell array 262. This placement of the reconfigurable metasurface unit cell array 262 facilitates the creation of a null region within the generated EMFs, effectively reducing EMF exposure at or around the user in a direction around and toward as user, such as a user sitting before a display screen. In yet other embodiments, the placement of the reconfigurable metasurface unit cell array 262 on the A-cover 283, EMFs generated by electromagnetic (EM) waves transmitted and received by antennas 292-1, 292-2, 292-3, and 292-4 can be controlled via both the creation EM wave radiofrequency transmission lobes 297 in other directions away from a user as well as creation of null regions for the user location to generally direct EM waves towards a target wireless device such as an access point 246 or base station 244 but reduce user EMF exposure in various embodiments herein and depending on radiofrequency environment conditions and bandwidth needs. In various embodiments herein, a plurality of antennas 292-1, 292-2, 292-3, 292-4 may be formed on a periphery of the reconfigurable metasurface unit cell array 262 or nearby the reconfigurable metasurface unit cell array 262 as well as placement of antennas at various other parts of the information handling system 200 chassis.

The reconfigurable metasurface unit cell array 262 may, in an embodiment, include a metasurface PMU 272 if not powered by a PMU (e.g., 128) of the information handling system 200. The metasurface PMU 272 may be used to power the devices, circuits, and elements operatively coupled to and/or formed onto the reconfigurable metasurface unit cell array 262. In an embodiment, the metasurface PMU 272 may include a metasurface battery 274 that is used by the metasurface PMU 272 to power those devices. Alternatively, and in another embodiment, the metasurface PMU 272 may include a metasurface A/C power adapter 276 that regulates power received from an A/C power source such as that of the information handling system 200. In this embodiment, the metasurface PMU 272 may be operatively coupled to the PMU (e.g., 128 in FIG. 1) of the information handling system 200 such that the PMU (e.g., 128) and metasurface PMU 272 operate together to provide power to those devices associated with the reconfigurable metasurface unit cell array 262 as described herein.

In an embodiment, the reconfigurable metasurface unit cell array 262 includes a plurality of reconfigurable metasurface unit cells 298-1 through 298-9 shown in FIG. 2. The plurality of addressable reconfigurable metasurface unit cells include, for example, a first metasurface unit cell 298-1, a second metasurface unit cell 298-2, a third metasurface unit cell 298-3, a fourth metasurface unit cell 298-4, a fifth metasurface unit cell 298-5, a sixth metasurface unit cell 298-6, a seventh metasurface unit cell 298-7, an eighth metasurface unit cell 298-8, and a ninth metasurface unit cell 298-9. It is appreciated, however, that the reconfigurable metasurface unit cell array 262 may include more than the nine reconfigurable metasurface unit cells 298-1 through 298-9 shown in FIG. 2 in various embodiments. In an embodiment, the reconfigurable metasurface unit cell array 262 may include an array of addressable reconfigurable metasurface unit cells 298-1 through 298-9 arranged in rows and columns that may include the nine-by-nine array of reconfigurable metasurface unit cells 298-1 through 298-9. It is appreciated, however, that any arrangement and any number of addressable reconfigurable metasurface unit cells (e.g., 298-1 through 298-9) may be used to form the reconfigurable metasurface unit cell array 262 described herein. In an embodiment, a plurality of reconfigurable metasurface unit cells 298-1 through 298-9 may form a unit cell subgroup 296 with the reconfigurable metasurface unit cell array 262 that includes a plurality of subgroups of reconfigurable metasurface unit cells 298-1 through 298-9. In an embodiment, each unit cell subgroup 296 may include reconfigurable metasurface unit cells 298-1 through 298-9 with each unit cell subgroup 296 being operatively coupled to the metasurface controller 278 that controls the operation of each of the unit cell subgroup 296 as well as capable to address each respective reconfigurable metasurface unit cells 298-1 through 298-9 and, therefore, apply controls to each metasurface unit cell 298-1 through 298-9 individually to adjust phase shifting of reflected EM waves by each reconfigurable metasurface unit cell 298-1 to 298-9.

In an embodiment, each metasurface unit cell 298-1 through 298-9 may be operatively controlled by the metasurface controller 278. In order to control the operation of each of the reconfigurable metasurface unit cells 298-1 through 298-9 and/or a unit cell subgroups 296 within the reconfigurable metasurface unit cell array 262 as well as control of a plurality of antennas 292-1, 292-2, 292-3, 292-4, the metasurface controller 278 may control the operation of a switch circuit 280 to switch between sending metasurface controller 278 commands to address reconfigurable metasurface unit cells 298-1 to 298-9 and commands sent to a wireless adapter (e.g., 134 in FIG. 1) controlling operation of the first antenna 292-1, the second antenna 292-2, the third antenna 292-3, the fourth antenna 292-4 or other antennas of the information handling system 200. In one embodiment, the plurality of antennas 292-1 through 292-4 may be co-located on a panel of the reconfigurable metasurface unit cell array 262, such as around the reconfigurable metasurface unit cells 298-1 to 298-9. In other embodiments, other antennas may be disposed on or around the display chassis 283 or base chassis of the information handling system 200.

The reconfigurable metasurface unit cells 298-1 to 298-9 may include one or more tunable delay circuits 286 for reconfigurable operation of each of the reconfigurable metasurface unit cells 298-1 to 298-9. In some embodiments, the metasurface controller may send a bias voltage to an attenuator circuit to adjust the amplitude of the reflected radiofrequency signal at each individual reconfigurable metasurface unit cells 298-1 through 298-9 to adjust a level of constructive interference via resonant structures among plural reconfigurable metasurface unit cells to the incident radiofrequency signal created by phase adjustment operation of a tunable delay circuit of each reconfigurable metasurface unit cell. Further, in an embodiment, the metasurface controller may send a bias voltage to a tunable delay circuit to phase shift the captured, incident radiofrequency signal to generate a reflected radiofrequency signal phase shifted with other reconfigurable metasurface unit cells to beamform a directional lobe among the plural adjacent reconfigurable metasurface unit cells from interference patterns reflected from the incoming EM waves of the incident radiofrequency signal. Thus, the reconfigurable metasurface unit cell array creates directional EM wave radiofrequency transmission or reception lobes 297 with an associated signal gain within the reflected EM waves of the incident radiofrequency signal. In an embodiment, the reconfigurable metasurface unit cell array may include a signal matching circuit operatively coupled to each of the microwave circuits of the plurality of reconfigurable metasurface unit cells to match the impedance received from each of a plurality of microwave circuits prior to feeding the captured, incident radiofrequency signal to a tunable delay circuit for phase shifting. In another embodiment, the metasurface controller may send a bias voltage to the tunable delay circuit to phase shift the captured, incident radiofrequency signal at each reconfigurable metasurface unit cell to generate a reflected radiofrequency signals among the plural metasurface unit cells to create a null region interference pattern in the reflected incident radiofrequency signal to create reduced EM waves on a particular side of the information handling system.

In other embodiments, each of the reconfigurable metasurface unit cells 298-1 to 298-9 may include reconfigurable resonant structures formed on a substrate for reflecting incident EM waves of radiofrequency signals and adjusting phase shifting of those reflected EM waves. The reconfigurable resonant structures may include resonant structures made of phase change material that can be switched between conductive material phase to a dielectric material phase with pulsed head from nearby heaters. For example, each of the reconfigurable metasurface unit cells 298-1 to 298-9 may include a set of concentric circular metasurface reconfigurable split rings in an embodiment that receive incident EM waves and reflect those incident EM waves propagated omnidirectionally from one or more of the antennas 292-1, 292-2, 292-3, 292-4 or received from the radiofrequency environment. Some portion of the concentric rings may be formed of phase change material and have associated refractory heaters to change the conductive or dielectric material state with pulses of voltage or current to the refractory heaters.

While concentric circular metasurface reconfigurable split rings are discussed in embodiments of reconfigurable metasurface unit cells 298-1 to 298-9 herein, any shape of concentric metasurface reconfigurable split rings for the metasurface unit cell 298-1 to 298-9 may be used. These concentric circular metasurface reconfigurable split rings of the reconfigurable metasurface unit cells 298-1 to 298-9 may receive those incident EM waves and resonate at a specific frequency. In an embodiment, the metasurface controller 278 may manipulate the individual unit cells 298-1 to 298-9 such that incident EM wave energy may be reflected in a certain direction from the concentric circular metasurface reconfigurable split rings by receiving input signals to change a phase change material to control the directionality of the reflected EM wave across the plural reconfigurable metasurface unit cells 298-1 to 298-9 of the reconfigurable metasurface unit cell array 262.

In order to create the null region within the EMF of radiofrequency signals at the information handling system 200, destructive interference may be employed by the reconfigurable metasurface unit cell array 262. In an example embodiment, when the EM waves from the antennas 292-1, 292-2, 292-3, 292-4 interact with the reflected, phase-shifted RF signals from the reconfigurable metasurface unit cell array 262, a phase alignment from the operation of individual unit cells 298-1 through 298-2 may be tuned such that troughs of the reflected radiofrequency signal from the some reconfigurable metasurface unit cells 298-1 through 298-2 align or correspond to any degree with peaks of the reflected radio frequency from other reconfigurable metasurface unit cells 298-1 through 298-2 or of the transmitted radiofrequency signal thereby cancelling or reducing the EM wave energy in a particular direction and creating the null region in that direction. This null region, in an embodiment, may be created at a location around the laptop-type information handling system 200 where the user will be interacting with the information handling system 200 such as in front of the keyboard 252 or the digital display device 250. Amplitude control by the attenuator circuit ensures that the signals have equal by opposite magnitudes thereby enhancing the cancellation effect in some embodiments. It is appreciated that constructive interference techniques may also be employed such that, outside the null region created, the phase and amplitude adjustments by the metasurface controller 278 strengthens the reflected EM signals from across the reconfigurable metasurface unit cells 298-1 through 298-2 in different beamforming direction away from a user in other embodiments. In this way, the reconfigurable metasurface unit cells 298-1 through 298-2 of the reconfigurable metasurface unit cell array 262 extends the EM radiofrequency signal lobes 297 for the transmission of the radiofrequency data signals. These EM radiofrequency signal lobes 297 may be beamformed towards a receiving device such as an AP 244, a base station 246, or another wireless information handling system for better transmission or reception of radiofrequency signals.

During operation, the information handling system 200 may operate the reconfigurable metasurface unit cell array 262 in a plurality of modes or states or combination of modes or states as described in embodiments herein. A first state may include an EMF mitigation and power saving mode where the reconfigurable metasurface unit cell array 262 operates to limit operation of the one or more antennas 292-1, 292-2, 292-3, 292-4. Further, if all radiofrequency signals of wireless links operating on the active antennas 292-1, 292-2, 292-3, 292-4 have sufficient RSSI and low enough SINR values, the reconfigurable metasurface unit cell array 262 may be adjusted to generate null regions for limiting user EMF exposure in some embodiments. This may be done by the hardware processor 202 of the information handling system 200 providing RSSI and SINR data, for example, to a metasurface controller 278 executing machine readable code instructions of an ACES module for controlling addressing of the reconfigurable metasurface unit cell array 262.

In an embodiment, the metasurface controller 278 executing machine readable code instructions of an ACES module may determine if, after an RSSI value has fallen below an RSSI threshold or and SINR value has fallen below an SINR threshold, whether the total power provided to any or all of the antennas 292-1, 292-2, 292-3, 292-4 exceeds a power threshold or not. If, for example, where the total power consumption by one or more of the antennas 292-1, 292-2, 292-3, 292-4 exceeds a power threshold (e.g., as defined by a power-saving mode at the information handling system), some or all of the antennas 292-1, 292-2, 292-3, 292-4 are deactivated and the reconfigurable metasurface unit cell array 262 may be activated or adjusted to provide beamforming lobes 297 with gain for one or more radiofrequency signals being transmitted by those one or more antennas 292-1, 292-2, 292-3, 292-4. Conversely, where the metasurface controller 278 executing machine readable code instructions of an ACES module determines that the total power consumption by one or more of the antennas 292-1, 292-2, 292-3, 292-4 does not exceed this power threshold, the reconfigurable metasurface unit cell array 262 may be maintained in its current configuration or otherwise deactivated allowing one or more of the antennas 292-1, 292-2, 292-3, 292-4 to continue to operate as before. In some embodiments, the metasurface controller 278 executing machine readable code instructions of an ACES module adjusts the addressable, reconfigurable metasurface unit cell array 262 to initiate EMF mitigation such that the reconfigurable metasurface unit cell array 262 creates, via a non-volatile phase change material or tunable delay circuit, the null region while also creating one or more EM radiofrequency signal lobes 297 described herein.

A second mode may include a signal enhancement mode where, when bandwidth requirements increase for radiofrequency signal transmission or reception, the metasurface controller 278 executing machine readable code instructions of an ACES module results in the hardware processor 202 of the information handling system 200 reducing the effects EMF mitigation via created null regions and the adjusts the phase shifting of the reflected EM waves by the reconfigurable metasurface unit cell array 262 such that transmitted and reflected EM waves for the radiofrequency signals from the antennas 292-1, 292-2, 292-3, 292-4 are enhanced or increased. Additionally, after activating switch circuit 280 to antenna control from metasurface control, the metasurface controller 278 executing the machine readable code instructions of the ACES module 294 may provide output to the hardware processor 202 of the information handing system 200 indicating that the antennas 292-1, 292-2, 292-3, 292-4 should be activated or remain active, and may even require increased power, due to data transception throughput requirement increases. In an embodiment, the bandwidth data and a determination that the RSSI values have fallen below an RSSI threshold and/or the SINR values have fallen below an SINR threshold may indicate that power to one or more of the antennas 292-1, 292-2, 292-3, 292-4 should be increased or that current power settings should be maintained and the reconfigurable metasurface unit cell array 262 should be adjusted to beamform in lobes 297 with signal gain for one or more radiofrequency signals.

During operation, the hardware processor 202 may execute machine readable program code of a device activation and management module 264. The device activation and management module 264 may interface with an RSSI sensor 266 and an SINR sensor 268 operating via a wireless interface adapter and radios for antennas 292-1 to 292-4, as well as, in an embodiment, a bandwidth monitoring module 270 to determine whether to direct the reconfigurable metasurface unit cell array 262 to operate in either an EMF mitigation and power saving mode or signal enhancement mode. For example, execution of machine readable code instructions of the adaptive device activation and management module 264 may interface with the RSSI sensor 266 via a wireless interface adapter to gather RSSI data from a radio controller and one or more antennas 292-1, 292-2, 292-3, 292-4. This RSSI sensor 266 detects the signal environment at and around the information handling system 200 by measuring the strength of the EM signals received at radio for the wireless interface adapter at the information handling system 200 via the antennas 292-1, 292-2, 292-3, 292-4. This may be expressed in terms of decibels (dBm). In an embodiment, the RSSI sensor 266 may continuously sense the dBm levels of EM signals at the information handling system or may be operated to occasionally monitor these dBm levels. The RSSI sensor 266 supplies real-time data to the hardware processor 202, and ultimately to the metasurface controller 378, with dBm levels for RF signals. The metasurface controller 278 executing machine readable code instructions of an ACES module compares current dBm levels to a baseline dBm level to determine if a threshold dBm level has been exceeded that may indicate that an RSSI has fallen below a threshold such that wireless communications are available, consistent, and strong enough for that RF signal or whether adjustment of the reconfigurable metasurface unit cell array 262 is warranted to generate beamforming lobes 297 with added gain for the RF signal as well as indicate whether a power increases to the antennas 292-1, 292-2, 292-3, 292-4 results should be instructed.

The SINR sensor 268 provides detailed feedback about the quality of the wireless signals being received and their susceptibility to interference and noise. In an embodiment, the SINR sensor 268 operates on a radio system of a wireless interface adapter of the information handling system 200 to evaluate the quality of wireless signals emitted or received by the antennas 292-1, 292-2, 292-3, 292-4 of the information handling system 200 or received from external sources. The SINR sensor 268 may help to determine whether the signal-to-noise conditions are sufficient for reliable communication between the information handling system 200 and other receiving/transmitting devices within the environment. As described herein, the data received by the hardware processor 202 from the RSSI sensor 266 and SINR sensor 268 helps to determine whether power can be reduced or turned off for any individual antenna 292-1, 292-2, 292-3, 292-4 and whether the reconfigurable metasurface unit cell array 262 may be activated or adjusted to engage in beamforming of lobes 297 with RF signal gain, whether to adjust the reconfigurable metasurface unit cell array 262 to generate a null region for EMF mitigation at the information handling system 200, or some combination.

In an embodiment, machine readable program code instructions of a bandwidth monitoring module 270 may also be executed by the hardware processor 202. The bandwidth monitoring module 270 may assess current and real-time bandwidth requirements of the information handling system 200 to ensure that wireless communication meets the user's needs while conserving power and minimizing unnecessary EM wave emissions when available. For example, the user may execute machine readable program code of an online gaming or video streaming software application. In so doing, the bandwidth requirements at the information handling system 200 may increase such that creation of the null region and powering down or turning off of any of the antennas 292-1, 292-2, 292-3, 292-4 may prevent an increase in bandwidth capacity at the information handling system 200. As such, the hardware processor 202, detecting an increase in bandwidth requirements via operation of the bandwidth monitoring module 270, may interact with the metasurface controller 278 executing machine readable code instructions of the ACES module 294 with an RF signal filtration and decision module 296. The metasurface controller 278 executing machine readable code instructions of the ACES module 294 with an RF signal filtration and decision module 296 may determine whether to decrease the size of a null region already created or eliminate the null region so that higher amounts of data may be transmitted by providing increased power to the one or more antennas 292-1, 292-2, 292-3, 292-4 for data transception. Additionally, the RSSI data and SINR data received from the RSSI sensor 266 and SINR sensor 268, respectively, may also be used by the metasurface controller 278 executing machine readable code instructions of the ACES module 294 with an RF signal filtration and decision module 296 to determine if the RSSI and SINR levels are above their respective thresholds such that antenna power can either be maintained or increased to maintain wireless communication. As described herein, reconfiguration of the individual addressable, reconfigurable metasurface unit cells 298-1 to 298-9 may be done at the reconfigurable metasurface unit cell array 262 with the metasurface controller 278 executing machine readable code instructions of the ACES module 294 to control the appropriate elements of the reconfigurable metasurface unit cell array 262 to reduce the null region or eliminate it. Further, the metasurface controller 278 executing machine readable code instructions of the ACES module 294 may execute the switch circuit 280 to provide instructions to the hardware processor 202 or wireless interface adapter at the information handling system to power up or increase power at the one or more antennas 292-1, 292-2, 292-3, 292-4. However, where the bandwidth requirements do not exceed a bandwidth threshold requirements, the hardware metasurface controller 278 executing machine readable code instructions of the ACES module 294 with an RF signal filtration and decision module 296 may continue to create the null region via the configuration of the reconfigurable metasurface unit cell array 262 and maintain a level of power to the one or more antennas 292-1, 292-2, 292-3, 292-4 as described herein.

Therefore, during operation of the device activation and management module 264, the hardware processor 202 may determine current EM environment using the data from the RSSI sensor 266, SINR sensor 268, and bandwidth monitoring module 270 and transmit the same to the metasurface controller 278 executing machine readable code instructions of the ACES module 294 with an RF signal filtration and decision module 296. Based on that data, the metasurface controller 278 executing machine readable code instructions of the ACES module 294 with an RF signal filtration and decision module 296 may operate to place the reconfigurable metasurface unit cell array 262 in either of the EMF mitigation and power saving mode or the signal enhancement mode and control adjustments to the reconfigurable metasurface unit cell array 262 and one or more antennas 292-1, 292-2, 292-3, 292-4. In order to switch between control of the reconfigurable metasurface unit cell array 262 and one or more antennas 292-1, 292-2, 292-3, 292-4, the metasurface controller 278 may operate a switch circuit 280 that switches from control voltages or current to the addressable the reconfigurable metasurface unit cell array 262 to control commands to the wireless interface adapter operating one or more antennas 292-1, 292-2, 292-3, 292-4.

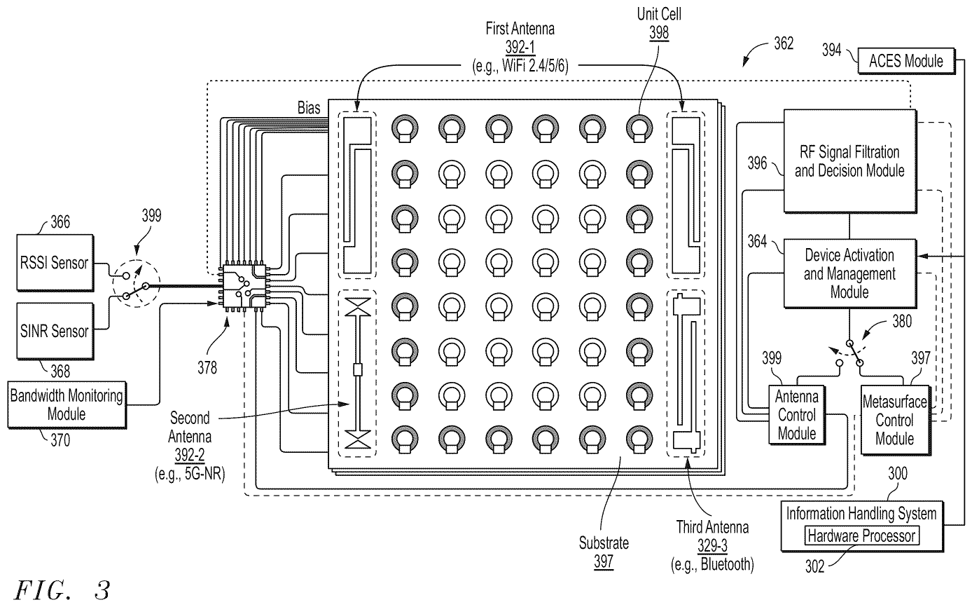

FIG. 3 is block and graphic diagram of a reconfigurable metasurface unit cell array operatively coupled to a metasurface controller executing machine readable code instructions of an RF signal filtration and decision module of an adaptive communication enhancement system (ACES) module according to an embodiment of the present disclosure. The metasurface controller 378 may be operatively coupled to an information handling system 300 that includes a hardware processor 302 that may execute machine readable program code of a device activation and management module 364 or an agent thereof to interface with an RSSI sensor 366 and an SINR sensor 368 operating with a wireless interface device as well as a bandwidth monitoring module 370 executing via the hardware processor 302 as described herein.

FIG. 3 shows an example addressable reconfigurable metasurface unit cell array 362 that includes an array of six-by-eight reconfigurable metasurface unit cells 398. In some embodiments, the reconfigurable metasurface unit cells 398 may be grouped into unit cell subgroups (e.g., 296, FIG. 2). It is appreciated, however, that this layout of reconfigurable metasurface unit cells 398 is merely an example and the present specification contemplates that the reconfigurable metasurface unit cell array 362 may include fewer or more than those reconfigurable metasurface unit cells 398 shown in FIG. 3. In an embodiment where the addressable reconfigurable metasurface unit cell array 362 is partitioned into unit cell subgroups described, each unit cell subgroup herein may also include any number of reconfigurable metasurface unit cells 398 thereby allowing for the formation of any number of unit cell subgroups. In an embodiment, the reconfigurable metasurface unit cell array 362 is reconfigurable by having switchable resonant structures or may have other switchable components such as varactors, variable capacitors, or a tunable delay circuit that operate to control the addressable reconfigurable metasurface unit cells 398 for generating directional lobes of reflected EM waves of an RF signal to enhance gain and directionality of RF signals emitted by the various antennas 392-1, 392-2, 392-3. In further embodiments, the reconfigurable metasurface unit cell array 362 is reconfigurable by having switchable resonant structures or may have other switchable components such as varactors, variable capacitors, or a tunable delay circuit that operate to control the addressable reconfigurable metasurface unit cells 398 for generating null regions of EM waves around a user's anticipated location for EMF mitigation.

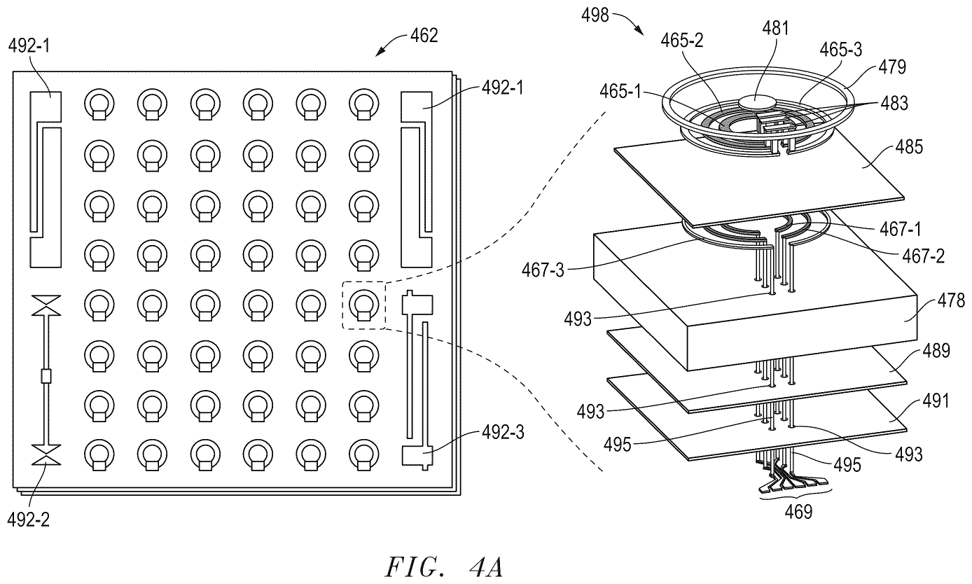

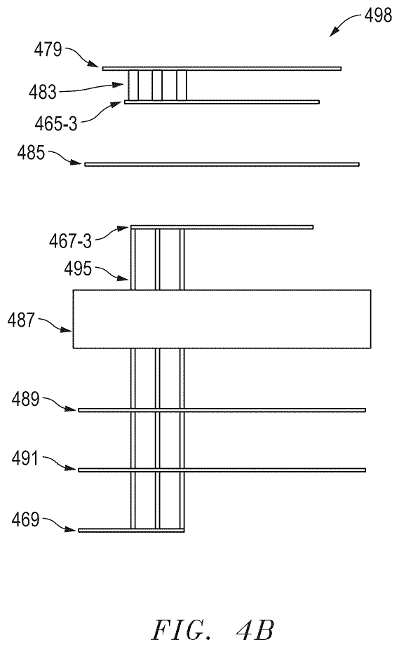

The reconfigurable metasurface unit cells 398 may be formed on to a substrate 397 which may include, for example, High Resistivity Silicon (HRSi), Aluminum Oxide (Al₂O₃), a printed circuit board (PCB), sapphire, glass, or other dielectric materials. As described further in FIGS. 4A and 4B below, the substrate 397 may have resonant structure thereon for each reconfigurable metasurface unit cell 398 that may be conductive material or phase shifting material that is switchable between a conductive state and a dielectric state.

FIG. 3 shows the metasurface controller 378 executing machine readable code instructions for an RF signal filtration and decision module 396 of an ACES module 394 in order to dynamically enhance the communication of the various antennas 392-1, 392-2, 392-3 via adjustments with the reconfigurable metasurface unit cell array 362. The ACES module 394 executed by a metasurface controller 178 interfaces with a device activation and management module 364 or an agent thereof executed by a hardware processor 302 of the information handling system 300 in some embodiments. Execution of the ACES module 394 by the metasurface controller 378 causes the metasurface controller 378 to communicate and request, at least, current RSSI data and SINR data from an RSSI sensor 366 and an SINR sensor 368 operating via one or more wireless interface adapters and radios of the information handling system 300. In an embodiment, the device activation and management module 364 may provide real-time RSSI and SINR data to the metasurface controller 378 during execution of the ACES module 394 and its RF signal filtration and detection module 396 as described herein. In an embodiment, execution of the machine readable program code instructions of the ACES module 394 evaluates a current communication environment within the wireless networks of a radiofrequency environment as well as workload and throughput data from the bandwidth monitoring module 370. Based on this data (e.g., RSSI data, SINR data, and workload and throughput data), the metasurface controller 378 may dynamically adjust transception power level related to each of the plurality antennas 392-1, 392-2, 392-3 and/or selectively deactivate non-essential antennas 392-1, 392-2, 392-3 in order to save power. Additionally, with this data (e.g., RSSI data, SINR data, and workload and throughput data), the metasurface controller 378 may address unit cells 398 of the reconfigurable metasurface unit cell array 362 in order to adjust beamforming and gain of reflected RF signals to enhance signal quality via, for example, beamforming those reflected RF signals incident to the surface of the reconfigurable metasurface unit cell array 362 within the radiofrequency environment including those RF signals from the any of the plurality of antennas 392-1, 392-2, 392-3.

In an embodiment, the SINR sensor 368 operating via a wireless interface device and radio may provide detailed feedback about the quality of the wireless RF signals being received and their susceptibility to interference and noise. In an embodiment, the SINR sensor 368 may evaluate the quality of wireless signals emitted by the antennas 392-1, 392-2, 392-3 of the information handling system or received from external sources. The SINR sensor 368 may help to determine whether the signal-to-noise conditions are sufficient for reliable communication between the information handling system and other receiving/transmitting devices within the environment. In an embodiment, the data received by the metasurface controller 378 from the RSSI sensor 366 and SINR sensor 368 is used by the metasurface controller executing machine readable code instructions of the ACES module to determine configuration of the reconfigurable metasurface unit cell array 362 for beamforming to enhance gain and directionality of reflected EM waves of one or more RF signals.

As described herein, the data received by the metasurface controller 378 from the RSSI sensor 366 and SINR sensor 368 also is used by the ACES module to determine whether a null region is to be created within the EMF of transmissions at the information handling system or not and whether power to one or more of the antennas 392-1, 392-2, 392-3 should be reduced or eliminated. For example, the hardware processor 302 may, based at least partially on the RSSI data and SINR data from the RSSI sensor 366 and SINR sensor 368, respectively, may switch a performance indicator switch 399 so that the metasurface controller 378 may receive the data from either the RSSI sensor 366 or SINR sensor 368 based on a mode the reconfigurable metasurface unit cell array 362 is to be placed in. These modes, as described herein, include an EMF mitigation and power saving mode or a signal enhancement mode.

In an embodiment, machine readable program code instructions of a bandwidth monitoring module 370 may also be executed by the hardware processor 302. The bandwidth monitoring module 370 may assess current and real-time bandwidth requirements of the information handling system to ensure that wireless communication meets the user's needs while minimizing unnecessary EM wave emissions and power consumption. For example, the user may execute machine readable program code of an online gaming or video streaming software application. In so doing, the bandwidth requirements at the information handling system may increase such that creation of the null region with the EM field and/or reduced power to the antennas 392-1, 392-2, 392-3 may prevent an increase in bandwidth capacity at the information handling system. As such, the hardware processor 302, detecting an increase in bandwidth requirements via operation of the bandwidth monitoring module 370, may transmit that data to the metasurface controller 378 is used by the ACES module to determine to decrease the size of any created null region or eliminate the null region and/or increase power provided to the antennas 392-1, 392-2, 392-3. Further, the data relating to increase in bandwidth requirements via operation of the bandwidth monitoring module 370 cause the metasurface controller 378 to adjust the reconfigurable metasurface unit cell array 362 for directional lobes with RF signal gain so that higher amounts of data may be transmitted without increase power to antennas 392-1, 392-2, 392-3. Accordingly, the hardware processor 302, detecting an increase in bandwidth requirements via operation of the bandwidth monitoring module 370, may send this data to the metasurface controller 378 which may then increase generation of an EM radiofrequency signal lobes and adjust directionality to improve wireless data transmission bandwidth in embodiments herein. As described herein, this may be done at the reconfigurable metasurface unit cell array 362 with the metasurface controller 378 to control the appropriate elements of the reconfigurable metasurface unit cell array 362 to reduce the null region or eliminate it or to increase or direct EM radiofrequency signal lobes in various embodiments. However, where the bandwidth requirements do not exceed the bandwidth threshold requirements, the hardware processor 302 may direct the metasurface controller 378 to continue to create the null region as described herein and/or reduce or eliminate power provided to some portion of or all of the antennas 392-1, 392-2, 392-3.

While the data from the RSSI sensor 366, SINR sensor 368, and bandwidth monitoring module 370 are being received (e.g., data indicating that the bandwidth requirements are low, the threshold dBm level has been exceeded, and the signal-to-noise conditions are sufficient for reliable communication between the information handling system and other receiving/transmitting devices within the environment), the metasurface controller 378 may cause a switch circuit 380 to selectively switch between an antenna control module 399 and a metasurface control module 397 that are used to optimize EM wave transception and mitigate EMF and power to the antennas 392-1, 392-2, 392-3.

As described herein, the reconfigurable metasurface unit cell array 362 includes a plurality of antennas 392-1, 392-2, 392-3 formed along a periphery of the reconfigurable metasurface unit cell array 362 on the same panel in some embodiments. A first antenna 392-1, for example, may include a WiFi 2.4/5/6 GHz antenna or a pair of such antennas. A second antenna 392-2 may include a 5G-NR antenna. Additionally, a third antenna 392-3 may include a Bluetooth® antenna. In an embodiment, the concentric circular metasurface reconfigurable split rings (not shown) of each metasurface unit cell 398 may be dynamically modified to resonate at one or all of the frequencies of antennas 392-1, 392-2 or 392-3 such that EM wave energy may be reflected off of the surface of the reconfigurable metasurface unit cell array 362 as described herein.

In order to create the null region within the EMF and thereby control the EMF exposure to the user, destructive interference may be employed by the reconfigurable metasurface unit cell array 362 with resonance of a reflected EM radiofrequency signal phase shifted relative to the detected incident radiofrequency signals across plural reconfigurable metasurface unit cells 398. In an example embodiment, when the EM waves from the antennas 392-1, 392-2, 392-3 interact with the reflected signals processed and reflected by the reconfigurable metasurface unit cell array 362, the phase alignment may be tuned such that troughs of the reflected signal from some reconfigurable metasurface unit cells 398 of the reconfigurable metasurface unit cell array 362 align with peaks of the incident radiofrequency signal or other reflected EM waves of other reconfigurable unit cells 398 thereby cancelling the EM wave energy and creating the null region that may be directional. Alternatively, alignment of the peaks for reflected radiofrequency signals among reconfigurable metasurface unit cells 398 of the reconfigurable metasurface unit cell array 362 may yield both constructive interference with directionality for one or more reflected EM radiofrequency signal lobes for transmission or reception as well as generated null regions in other directions. The generated null region, in an embodiment, may be created at a location around the laptop-type information handling system where the user will be interacting with the information handling system such as in front of the keyboard. In some embodiments, amplitude control by, for example, an attenuator circuit controlled by the metasurface controller 378, ensures that the signals have equal but opposite magnitudes thereby enhancing the cancellation effect for null regions, or alternatively increases the constructive interference of a directional lobe of reflected radiofrequency signal. It is appreciated that constructive interference techniques may also be employed such that, outside any null region created, the phase and amplitude adjustments by the metasurface controller strengthens the emitted EM signals in directional lobes to extend the EM radiofrequency signal lobes outside of any generated null region in some embodiments. The EM radiofrequency signal lobes may be beamformed towards a receiving device such as an AP, base station, or another wireless device for better transmission within a radiofrequency environment. Thus, where higher bandwidth requirements are needed pursuant to the data received from the bandwidth monitoring module 370 for example, the metasurface controller 378 may switch from the EMF mitigation and power saving mode to the signal enhancement mode as described herein.

FIG. 4A is a top view graphic diagram showing a reconfigurable metasurface unit cell array 462 and an exploded perspective view graphic diagram showing a single reconfigurable metasurface unit cell 498 according to an embodiment of the present disclosure. The reconfigurable metasurface unit cell array 462 shown in FIG. 4A may be similar to that reconfigurable metasurface unit cell array shown and described in FIG. 3. Similarly, FIG. 4B is a side view graphic diagram showing a reconfigurable metasurface unit cell 498 according to an embodiment of the present disclosure. Again, the reconfigurable metasurface unit cell array 462 shown in FIGS. 4A and 4B may be an entire reconfigurable metasurface unit cell array 462 or may form a subgrouping of reconfigurable metasurface unit cells 498 that may cooperate with similar subgroups of unit cells 498 to form a larger reconfigurable metasurface unit cell array 462. The reconfigurable metasurface unit cells 498 of FIGS. 4A and 4B are one example embodiment of reconfigurable metasurface unit cells that may be used in connection with the ACES module of embodiments of the present disclosure and other types of reconfigurable metasurface unit cells with different resonant structure layouts having reconfigurable resonant structure components or with tunable delay circuits are contemplated for use with embodiments of the present disclosure as well.

The reconfigurable metasurface unit cells 498 may be adjusted via reconfigurable resonant structure components (e.g., phase change material split rings 456-1, 465-2, and 465-3) or a tunable delay circuit (not shown) to dynamically modify the phase shift of reflected EM waves incident upon the surface of each reconfigurable metasurface unit cells 498 as described in embodiments herein. The phase shift of reflected EM waves across plural reconfigurable metasurface unit cells 498 may be used to create constructive or destructive interference patterns to generate directional lobes of reflected EM waves or to generate null regions with the reconfigurable metasurface unit cell array 462 in various embodiments. It is appreciated that each of the reconfigurable metasurface unit cells 498 of the reconfigurable metasurface unit cell array 462 may comprise their own various layers or may, in an embodiment, share the same layer or layers. Again, the reconfigurable metasurface unit cell 498 shown in FIGS. 4A and 4B may be one of a plurality of reconfigurable metasurface unit cells 498 that form the reconfigurable metasurface unit cell array 462 and may include any number of reconfigurable metasurface unit cells 498 arranged in any manner forming a two-dimensional structure. Further, the panel hosting the reconfigurable metasurface unit cells 498 of the reconfigurable metasurface unit cell array 462 may also include one or more antennas 492-1, 492-2, 492-3 according to embodiments herein.

As shown in FIGS. 4A and 4B, the reconfigurable metasurface unit cell 498 includes concentrically formed first metasurface reconfigurable split ring 465-1, second metasurface reconfigurable split ring 465-2, and third metasurface reconfigurable split ring 465-3 as phase changing resonant structures on a first layer of the reconfigurable metasurface unit cell 498. It is appreciated that while rings are shown as concentrically formed first metasurface reconfigurable split ring 465-1, second metasurface reconfigurable split ring 465-2, and third metasurface reconfigurable split ring 465-3, the phase changing resonant structure may be of any geometric shape including square, rectangular, oval, or the like or may be of a non-geometrical concentric shape in various embodiments. Each of these metasurface reconfigurable split rings 265-1, 265-2, 265-3 may include any phase change materials such as GeTe, SbTe, or GeSbTe among other similar non-volatile phase change materials and a conductive bridge 483 to complete the ring forming the phase changing reconfigurable resonant structures in embodiments herein. The metasurface reconfigurable split rings 465-1, 465-2, 465-3 share the same layer as a non-reconfigurable metal fixed ring 479 resonant structure, arranged as an outer ring in some embodiments or another location in other embodiments, and non-reconfigurable metal fixed center node 481. Again, a ring or other geometrical or non-geometrical shape may form the outer concentric shape in various embodiments. These metasurface reconfigurable split rings 465-1, 465-2, 465-3, the non-reconfigurable metal fixed ring 479, and a non-reconfigurable metal fixed center node 481 act together to control and focus the phase change for directionality of the EM wave beams incident to and reflected off of the plurality of reconfigurable metasurface unit cells 498 across the reconfigurable metasurface unit cell array 462. In an embodiment, the non-reconfigurable metal fixed ring 479 and non-reconfigurable metal fixed center node 481 may be made of a metal such as gold (Au), copper (Cu), aluminum (Al), nickel (Ni) among other types of conductive metals.

In an embodiment, each of the metasurface reconfigurable split rings 465-1, 465-2, 465-3 may include a split or gap along the circumference of the metasurface reconfigurable split rings 465-1, 465-2, 465-3. As shown in FIG. 4A, for example, this gap correlates with a gap in each of the respective refractory heaters 467-1, 467-2, 467-3 formed below the first layer formed by the metasurface reconfigurable split rings 465-1, 465-2, 465-3 and a first dielectric layer 485. This enables operation of the refractory heaters 467-1, 467-2, 467-3 to pulse heat to the phase change material of the metasurface reconfigurable split rings 465-1, 465-2, 465-3. In order to maintain the active beam steering capabilities of each of the metasurface reconfigurable split rings 465-1, 465-2, 465-3, this gap in each metasurface reconfigurable split rings 465-1, 465-2, 465-3 may be bridged using a conductive bridge 483. The conductive bridge 483 allows for induced currents in each of the metasurface reconfigurable split rings 465-1, 465-2, 465-3 to create or adjust radiated fields that form the controllable reflected wave patterns described herein.

Below this first layer comprised of the metasurface reconfigurable split rings 465-1, 465-2, 465-3, the non-reconfigurable metal fixed ring 479, and the non-reconfigurable metal fixed center node 481, the reconfigurable metasurface unit cell 498 includes a first dielectric layer 485. This first dielectric layer 485 may be made of SiNx of AlN. In an embodiment, this first dielectric layer 485 may include any insulating substance that does not conduct electricity but may also support electrostatic fields created during operation of the reconfigurable metasurface unit cell 498. Further, the first dielectric layer 485 may facilitate heat conduction between the refractory heaters 467-1, 467-2, 467-3 and the respective metasurface reconfigurable split rings 465-1, 465-2, 465-3.

Below the first dielectric layer 485, a second layer may be formed that comprises the first refractory heater 467-1, the second refractory heater 467-2, and the third refractory heater 467-3. The refractory heaters 467-1, 467-2, 467-3 may each, individually and selectively, heat their respective metasurface reconfigurable split rings 465-1, 465-2, 465-3 with high intensity short duration pulses of heat. Thus, when a power source is applied to the first refractory heater 467-1, the first refractory heater 467-1 heats the first metasurface reconfigurable split ring 465-1. Additionally, when the power source is applied to the second refractory heater 467-2, the second refractory heater 467-2 heats the second metasurface reconfigurable split ring 465-2. Further, when a power source is applied to the third refractory heater 467-3, the third refractory heater 467-3 heats the third metasurface reconfigurable split ring 465-3. Thus, the states of each of the metasurface reconfigurable split rings 465-1, 465-2, 465-3 may be individual controlled via pulse heating of the individual refractory heaters 467-1, 467-2, 467-3 such that the states of the metasurface reconfigurable split rings 465-1, 465-2, 465-3 may be switched from their amorphous states to their crystalline states or vice versa.

It is appreciated that the voltage and current applied to each of the refractory heaters 467-1, 467-2, 467-3 controls the states of the metasurface reconfigurable split rings 465-1, 465-2, 465-3. For example, where the voltage applied to any of the refractory heaters 467-1, 467-2, 467-3 is high (e.g., 15-20 V) for a short period of time (e.g., up to 0.5 microseconds (μs)) with a peak current of 300 to 310 mA, the metasurface reconfigurable split rings 465-1, 465-2, 465-3 are placed in an amorphous state. This application of this voltage at this current creates a peak temperature at a metasurface reconfigurable split rings 465-1, 465-2, 465-3 of 700 to 800° C. An average pulse power (W) may be initiated pulse heat to transition the phase change material the crystalline state having a lower resistance such that it is conductive and to the amorphous state having a substantially higher resistance such that it functions as a dielectric in order to transition from a conductive state to the dielectric state in this example. However, where the voltage applied to any of the refractory heaters 467-1, 467-2, 467-3 is relatively lower (e.g., 9-10 V) for a relatively longer period of time (e.g., 2 μs) with a peak current of 210 to 220 mA the metasurface reconfigurable split rings 465-1, 465-2, 465-3 are switched back to a crystalline state in an embodiment. This application of this voltage and current creates a peak temperature at a metasurface reconfigurable split rings 465-1, 465-2, 465-3 of 400 to 410° C. It is appreciated that heat pulses are needed in order to place the non-volatile phase change material of the metasurface reconfigurable split rings 465-1, 465-2, 465-3 into an amorphous state or a crystalline state depends on the type of non-volatile phase change material used. Thus, the electrical pulse from the metasurface PMU (e.g., FIGS. 1, 172) at an applied voltage and current to each of the refractory heaters 467-1, 467-2, 467-3 to change the state of the non-volatile phase change material of each metasurface reconfigurable split rings 465-1, 465-2, 465-3 may depend on the type of non-volatile phase change material used. The present specification contemplates that any of a plurality of non-volatile phase change materials may be used necessitating changes in these applied voltages and currents.

Other layers and substrates may also be included in the stack within the reconfigurable metasurface unit cell 498. In an example embodiment, the reconfigurable metasurface unit cell 498 may further include an electrical dielectric substrate 487 placed below the second layer that comprises the refractory heaters 467-1, 467-2, 467-3. This electrical dielectric substrate 487 may be made of a HRSi, Al2O3, glass, or PCB among other dielectric materials. In an embodiment, the first dielectric layer 485 and electrical dielectric substrate 487 may electrically isolate the refractory heaters 467-1, 467-2, 467-3 from the remaining portions of the reconfigurable metasurface unit cell 498.

In an embodiment, a metallization layer 489 may be formed below the electrical dielectric substrate 487. This metallization layer 489 may be made of Au, Cu, Al, or Ni among other types of metals. In an embodiment, this metallization layer 489 may serve as an RF grounding source for the reconfigurable metasurface unit cell 498.

In an embodiment, a second dielectric layer 491 may be placed below the metallization layer 487. This second dielectric layer 491 may be made of silicon dioxide (SiO2). Similar to the first dielectric layer 485, the second dielectric layer 491 may also support electrostatic fields created during the operation of the unit cell 498. In other embodiments, the second dielectric layer 491 may have limited thermal conductivity.

Below the second dielectric layer 491, a number of contact pads 469 used to electrically couple the refractory heaters 467-1, 467-2, 467-3 to a metasurface PMU (e.g., FIG. 1 172) is shown. The contact pads 469 may be made of any conductive metal such as Au, Cu, Al, or Ni among other types of metals. The contact pads 469 may receive those electrical pulses from the metasurface PMU in order to pulse heat, individually, each of the refractory heaters 467-1, 467-2, 467-3. In order to operatively couple each of the refractory heaters 467-1, 467-2, 467-3 to a respective contact pad 469, a plurality of metal interconnect layers 495 are formed. In the example embodiment shown in FIGS. 4A and 4B, the metal interconnect layers 495 couple a contact pad 469 to each terminal end of each of the refractory heaters 467-1, 467-2, 467-3. In order to do so, one or more vias 493 are formed through, at least, the second dielectric layer 487, the metallization layer 489, and the electrical dielectric substrate 491 so that the metal interconnect layers 495 may pass from each of the respective contact pads 469 to their respective refractory heaters 467-1, 467-2, 467-3.

FIGS. 4A and 4B show a single reconfigurable metasurface unit cell 498 among a plurality of reconfigurable metasurface unit cell 498 that may form the reconfigurable metasurface unit cell array 462. It is appreciated that the reconfigurable metasurface unit cell array 462 may comprise any number of individually activatable reconfigurable metasurface unit cells 498. In one example embodiment, the reconfigurable metasurface unit cell array 462 may place the reconfigurable metasurface unit cell 498 in a row and column orientation thereby forming, for example, a sixteen-by-sixteen addressable reconfigurable metasurface unit cell array 462. During operation, as described herein, each refractory heater 467-1, 467-2, 467-3 are individually heated using the contact pads 469 such that each of the metasurface reconfigurable split ring 465-1, 465-2, 465-3, individually, undergo a phase change into an amorphous state or a crystalline state thereby changing the EM wave reflective properties of each individual reconfigurable metasurface unit cell 498 and allowing plural EM wave directions to be controlled with the reconfigurable metasurface unit cells 498 in the array. By selectively changing the individual EM wave reflective properties of each individual addressable reconfigurable metasurface unit cell 498, the reconfigurable metasurface unit cell array 462 may also change the directionality and feed distance of the reflected EM wave such that the reconfigurable metasurface unit cell array 462 may phase change the reflected EM wave which may be used with adjacent addressable reconfigurable metasurface unit cells 498 to beamform to a specific location and/or receiving device (e.g., FIGS. 1, 178). Because of the reflective directionality of the reconfigurable metasurface unit cell array 462 may be changed readily (e.g., in the order of microseconds or nanoseconds), a single reconfigurable metasurface unit cell array 462 may be reconfigured to relay data in radiofrequency signals via these EM waves to multiple receiving devices. Thus, in an environment where 5G or other EM waves are being relayed, the presently-described reconfigurable metasurface unit cell array 462 may relay radiofrequency signal data around corners or along long distances in a radiofrequency environment in order to transmit that data to the appropriate receiving device.

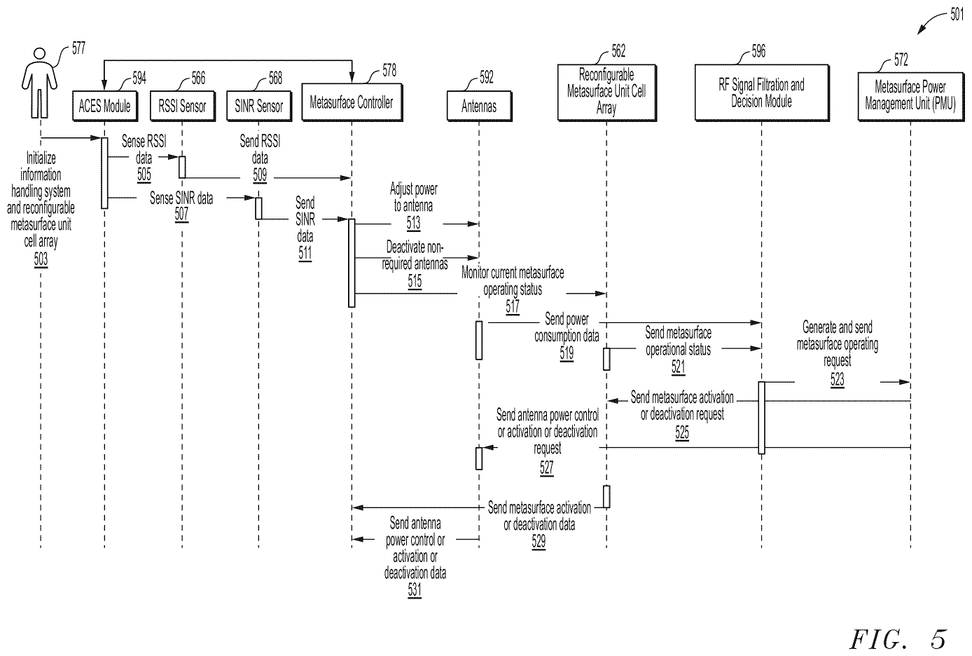

FIG. 5 is a swim lane diagram showing a method 501 of adaptively enhancing a communication system at a reconfigurable metasurface unit cell array 562 formed on an information handling system according to an embodiment of the present disclosure. In an embodiment, the reconfigurable metasurface unit cell array 562 may be affixed to a display chassis cover of the laptop-type information handling system such as the A-cover of a laptop type information handling system or the back of a tablet type information handling system. The A-cover may include a top portion of the lid of the laptop-type information handling system housing an integrated digital display device, for example. The placement of the reconfigurable metasurface unit cell array 562 may include one or more wireless antennas 592 on the A-cover of the laptop-type information handling system or the back of a tablet-type information handling system to allow the EM waves of those radiofrequency signals that are received and transmitted by the one or more antennas 592 to be reflected by the reconfigurable metasurface unit cell array 562. Further, the EM waves of those radiofrequency signals that are received and transmitted by the one or more antennas 592 and reflected by the reconfigurable metasurface unit cell array 562 may be controlled by execution of machine readable code instructions of the ACES module according to embodiments herein.

The method 501 may include a user 577 initiating the information handling system with antennas 592 and the reconfigurable metasurface unit cell array 562 at line 503. In an embodiment, this may include a user 577 actuating a button on the information handling system and/or the reconfigurable metasurface unit cell array 562. The user 577 have access to a button on the reconfigurable metasurface unit cell array 562, in some embodiments, that allows the reconfigurable metasurface unit cell array 562 to be powered independently from the information handling system using a metasurface PMU described herein. However, in an example embodiment, the reconfigurable metasurface unit cell array 562 is operatively coupled to the information handling system and a PMU of the information handling system such that actuation of the button on the information handling system causes the PMU of the information handling system to also provide power to the reconfigurable metasurface unit cell array 562 and, specifically, a metasurface controller 578.

At line 505, the metasurface controller 578 executes machine readable code instructions of the ACES module 594 to request that an RSSI sensor 566 send, at line 509, RSSI data to the metasurface controller 578 indicating RSSI levels of one or more wireless links between antenna or antennas 592 and a receiver wireless device in a radiofrequency environment. It is appreciated that the RSSI sensor 566 may be formed within the information handling system or on the reconfigurable metasurface unit cell array 562 and operated via a wireless adapter of the information handling system determining signal strength levels of transmitted or received EM waves of radiofrequency signals. In either example embodiment, the metasurface controller 578 executing machine readable code instructions of the ACES module 594 being may send this request to wireless adapter and its RSSI sensor 566 in an embodiment as described. At line 509, the RSSI sensor 566 and wireless adapter sends the RSSI data for one or more radiofrequency signals to the metasurface controller 578. It is appreciated that the metasurface controller 578, executing the machine readable program code instructions of the ACES module 594, may determine whether the RSSI data has exceeded a RSSI threshold indicating that the received signal strength of any given wireless communication is powerful enough, in terms of dBm, to sustain communication at any of the antennas 592 with a receiver wireless device in a radiofrequency environment.

Similarly, the metasurface controller 578 executes machine readable code instructions of the ACES module 594 to request that an SINR sensor 568 send, at line 507, SINR data to the metasurface controller 578. It is appreciated that the SINR sensor 568 may be formed within the information handling system or on the reconfigurable metasurface unit cell array 562 and operate with the wireless adapter at the information handling system. In either example embodiment, the metasurface controller 578 executes machine readable code instructions of the ACES module 594 to send this request to the wireless adapter operating the SINR sensor 568 as described to determine signal strength and noise levels at the antennas 592. At line 511, the SINR sensor 568 and wireless adapter sends the SINR data for one or more radiofrequency signals to the metasurface controller 578. It is appreciated that the metasurface controller 578, executing the machine readable program code instructions of the ACES module 594, may determine whether the SINR levels are maintained above an SINR threshold indicating that the signal to noise ratio is high enough to sustain uninterrupted wireless communication at any of the antennas 592 with receiver wireless devices in the radiofrequency environment.

As described herein, after the metasurface controller 578 has determined that the RSSI data of wireless signals from the RSSI sensor 566 does not fall below an RSSI threshold level and that the SINR data of those wireless signals does not fall below an SINR threshold, the metasurface controller 578 may indicate that transmission at the one or more antennas 592 is sufficient to maintain wireless communications via the current radiofrequency signals. As such, in an embodiment, the metasurface controller 578 may, at line 517, monitor for current operating status of the reconfigurable metasurface unit cell array 562. For example, the wireless information handling system may be communicating using the plurality of antennas 592 of the reconfigurable metasurface unit cell array 562, all of which are needed for wireless communication by the information handling system. Again, this may be because high data throughput rates as defined by a bandwidth monitoring module (e.g., FIGS. 1, 170) are being experienced such that the current level of power provided to and use of these antennas 592 is warranted. In such embodiments, the metasurface controller executing machine readable code instructions of the ACES module may control power levels of one or more antennas 592 to increase power to the one or more used antennas 592 when all are necessary at block 513 to improve RSSI at the one or more of the plurality of antennas 592.

In other embodiments, the wireless information handling system may be communicating using some portion of the plurality of antennas 592 or even one selected antenna 592 of the reconfigurable metasurface unit cell array 562, such that not all antennas are needed for wireless communication by the information handling system. In such embodiments, the metasurface controller executing machine readable code instructions of the ACES module may control power levels of one or more antennas 592 to turn off unused antennas while increasing power to the one or more used antennas at blocks 513 and 515.

In this example embodiment, where the received RSSI data indicates that the RSSI level has not fallen below the RSSI threshold and the received SINR data indicates that the SINR level has not fallen below the SINR threshold, the metasurface controller 578 executes machine readable code instructions to remain in the current mode or configuration by not making changes to the reconfigurable metasurface unit cell array 562 and allowing the antennas 592 to be powered at current power levels without changes to the reconfigurable metasurface unit cell array 562. Additionally, bandwidth throughput data is received from the bandwidth monitoring module at the metasurface controller 578 indicating whether additional power is to be provided at line 513 to one or more antennas 592.

In some embodiments, the metasurface controller 578 may also reconfigure the reconfigurable metasurface unit cell array 562 via execution of machine readable code instructions of the ACES module 594 and with the metasurface PMU in order to engage in beamforming processes described herein to reflect radiofrequency signals with additional gain from the plural antennas 592. Further, to the extent that the reconfigurable metasurface unit cell array 562 is being used to generate a null region, such as to reduce EMF exposure to a user 577, the area of the created null region may need to be reduced to provide for improved RSSI, lowered SINR, or increased bandwidth throughput in some embodiments herein.

In an example embodiment, in instances where some antennas 592 are activated and operating such that power is being consumed without wireless communication being initiated with the individual antenna 592 or plural antennas 592, such as when some portion of antennas 592 are inactive, such antennas may be reduced or deactivated at line 513. However, in other embodiments, the total power consumption at the antennas 592 be increased by the ACES module to increase RSSI, SINR or other signal levels. The antennas 592, or one or more wireless adapters for those antennas 592, may send power consumption data at line 519 to the metasurface controller 587 executing machine readable code instructions of a RF signal filtration and decision module 596 working in connection with the ACES module 594 in some embodiments. Additionally, at line 521, the RF signal filtration and decision module 596 working in connection with the ACES module 594 via execution by the metasurface controller 578 may receive metasurface operational status indicating current directionality, gain, null regions active, as well as radiofrequency signal being reflected by the reconfigurable metasurface unit cell array 562. This power consumption data and current metasurface operational status may further inform the metasurface controller 578 whether the reconfigurable metasurface unit cell array 562 should be activated or reconfigured to accommodate reflection of radiofrequency signals to enable for lower power to be provided to the one or more antennas 592 if necessary.

At line 513, therefore, where either the RSSI data has fallen below the RSSI threshold (e.g., dBm is too low) or the SINR data has fallen below the SINR threshold (e.g., too much noise in the signal), the method 501 may continue with lines 513 and 515. For example, at line 515, the metasurface controller 578 may generate data describing how to adjust the power provided to any of the antennas 592. In an embodiment, a power attenuator may be used to reduce or entirely eliminate power provided to those antennas 592 that can be powered down. This may also reduce the EMF from those particular antennas around the information handling system thereby reducing EMF exposure to the user. Thus, at line 515 power to any given antenna 592 may be reduced while at line 515, one or more antennas 592 not currently being used are deactivated. In other embodiments, power may be increased to one or more antennas 592 at line 515 even when all antennas are still needed for communications or even increases at some subset of antennas may be a substantial increase in overall power consumption of the information handling system.

At line 517, power consumption data may be sent from a radio and wireless adapter associated with any or all of the plurality of antennas 592 to the RF signal filtration and decision module 596. The RF signal filtration and decision module 596 may execute as part of the ACES module 594 via the metasurface controller 578 in some embodiments or may execute separately by the metasurface controller 578 or at a hardware processor of the information handling system in other embodiments. Concurrently, at line 521, the metasurface controller 578 of the reconfigurable metasurface unit cell array 562 may send metasurface operational status to the RF signal filtration and decision module 596. Execution of the machine readable program code instructions of the RF signal filtration and decision module 596 may provide, as output, data related to how power to each of the antennas 592 and when or how the reconfigurable metasurface unit cell array 562 is to be altered in order to concurrently directionally reflect radiofrequency signals and increase gain while engaging in power saving processes to reduce overall power consumed by the antennas 592 described herein. In further embodiments, the execution of the machine readable program code instructions of the RF signal filtration and decision module 596 also determines if and how the reconfigurable metasurface unit cell array 562 should be reconfigured to create or reduce a null region as well as beamform any reflected EM waves received incident to the reconfigurable metasurface unit cell array 562 to provide EMF protection as well as improved signal quality by one or more of the antennas 592.

The RF signal filtration and decision module 596 may then, at line 523 generate and send a metasurface operating request to the metasurface PMU 572 to indicate to the metasurface PMU 572 whether the addressable reconfigurable metasurface unit cells of the reconfigurable metasurface unit cell array 562 are to be reconfigured based on the data received at the RF signal filtration and decision module 596. The addressable reconfigurable metasurface unit cells of the reconfigurable metasurface unit cell array 562 may be provided power by the metasurface PMU 572 at line 525 to heat refractory heaters for example to activate or deactivate conductive state of one or more concentric rings of a resonant structure for each reconfigurable metasurface unit cell according to example embodiments herein. In other embodiments, the metasurface PMU 572 may provide power to tune a tunable delay circuit of one or more reconfigurable metasurface unit cells of the reconfigurable metasurface unit cell array 562 at line 525 to adjust the phase change of reflected EM waves in particular radiofrequency signals. In an example embodiment, where the total power consumption at the one or more antennas 592 currently exceeds a power threshold, the reconfigurable metasurface unit cell array 562 may be activated such that power reduction to one or more of the antennas 592 may be accommodated by the reconfigurable metasurface unit cell array 562 increasing the beamforming capabilities of any individual antenna 592 without increasing power levels at that antenna 592. Still further, a null region within the EMF may be created limiting the EMF exposure to the user 577.

Thus, at line 525, the metasurface PMU 572 may send an activation or deactivation request addressing one or more reconfigurable metasurface unit cells of the reconfigurable metasurface unit cell array 562 via a power signal from the metasurface PMU 572 at line 525 to the reconfigurable metasurface unit cell array 562 as determined from the generated request at line 523. Additionally, the metasurface PMU 572 may send antenna power control and/or a deactivation or activation request to the antennas 592 at line 527 pursuant to the generated request at line 523 from execution of the machine readable code instructions of the RF signal filtration and decision module 596 as described herein.

In an embodiment, the reconfigurable metasurface unit cell array 562 may report the activation or deactivation status of the addressable reconfigurable metasurface unit cells in the reconfigurable metasurface unit cell array 562 to the metasurface controller 578 at line 529. Concurrently, the radios of the antennas 592 may report antenna power control and/or activation or deactivation data to the metasurface controller 578 at line 531. This provides the metasurface controller 578 with data defining whether the signal enhancement mode has been activated per instructions sent earlier or whether an EMF mitigation and power saving mode is in operation as well as directionality and gain provided to one or more radiofrequency signals from the configuration of the reconfigurable metasurface unit cell array 562. In an embodiment, the method 501 may also determine if the information handling system and/or reconfigurable metasurface unit cell array 562 are still initiated. Where either the information handling system or reconfigurable metasurface unit cell array 562 are still initiated, the method 501 may continue with the ACES module 594 directing RSSI data and/or SINR data to be sent to the metasurface controller 578 as described above to monitor radiofrequencies transmitted or received by one or more antennas 592. Where either the reconfigurable metasurface unit cell array 562 or information handling system is no longer initiated, the method 501 may end.

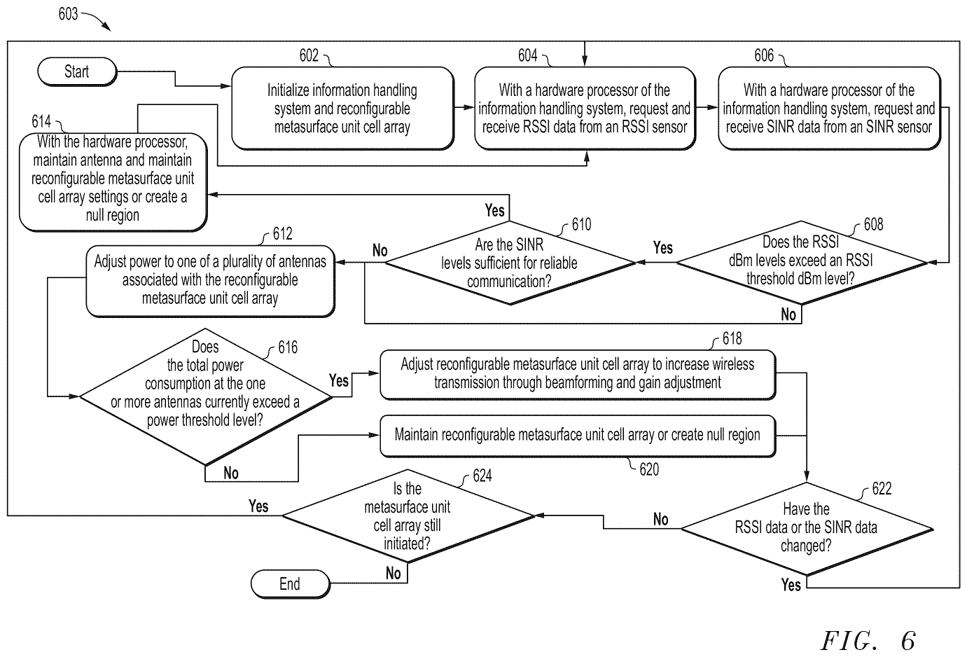

FIG. 6 is a flow diagram of a method 603 of executing machine readable code instructions for an adaptive communication enhancement system (ACES) module at a reconfigurable metasurface unit cell array with plural antennas formed on an information handling system according to an embodiment of the present disclosure. The reconfigurable metasurface unit cell array used in this method may be similar to those reconfigurable metasurface unit cell arrays described in connection with, for example, FIGS. 1 through 3 and may include a plurality of reconfigurable metasurface unit cells as described in connection with FIGS. 4A and 4B or any other types of reconfigurable metasurface unit cells that are addressable and adjustable for phase shift in reflection of incident EM waves of radiofrequency signals. The reconfigurable metasurface unit cell array may include a plurality of reconfigurable metasurface unit cells that are individually controlled via a metasurface controller and using a metasurface PMU or other power source as well as other components to adjust phase shifting of reflected EM waves by resonant structures on the reconfigurable metasurface unit cells as described in embodiments herein.

At block 602, the method 900 may include initiating the information handling system having the reconfigurable metasurface unit cell array and a plurality of antennas for plural wireless transmissions or receptions in a radiofrequency environment. In an embodiment, the information handling system may be initiated by a user actuating a power button at the information handling system. In an example embodiment, the PMU of the information handling system may then proceed to power a hardware processor, one or more wireless adapters, memory and other components of the wireless information handling system as well as a metasurface controller of a reconfigurable metasurface unit cell array. In an embodiment, the reconfigurable metasurface unit cell array may be placed on a surface, such as a chassis surface of the information handling system, where EM waves may arrive at the reconfigurable metasurface unit cell array as well as be transmitted from one or more antennas of the information handling system. In one embodiment, the reconfigurable metasurface unit cell array may be a panel of reconfigurable metasurface unit cells and include plural wireless antennas around the reconfigurable metasurface unit cells. The chassis surface of the information handling system may include an A-cover of an information handling system such as that shown in FIG. 2 in one example embodiment.

Upon initiation or during operation of the reconfigurable metasurface unit cell array, any incident radiofrequency signal EM waves, including those transmitted from or being received by the plurality of wireless antennas, may be captured and reflected by the reconfigurable metasurface unit cells. The reflected incident radiofrequency signal EM waves are phase shifted across the plurality of reconfigurable metasurface unit cells and may be beamformed or form a null region depending on the selected phase shifting interference pattern of constructive or destructive interference across the reconfigurable metasurface unit cells. This may be done with conductivity phase alterations of resonant structures of the reconfigurable metasurface unit cells or with a microwave coupler and microwave circuitry in various example embodiments. In such a way, the captured and reflected incident radiofrequency signals may be manipulated for phase shifting to generate a reflected radiofrequency signal across the plurality reconfigurable metasurface unit cells in the reconfigurable metasurface unit cell array according to embodiments herein. It is appreciated that the reconfigurable metasurface unit cell array may interact with those EM waves emitted by the number of wireless antennas placed around a periphery of the reconfigurable metasurface unit cell array in embodiments herein. The reflected radiofrequency signal at any of the one or more reconfigurable metasurface unit cells may generate directional EM wave radiofrequency signal transmission or reception lobes with the reflected incident radiofrequency signals or generate null regions at the reconfigurable metasurface unit cell array via constructive or destructive interference across the reconfigurable metasurface unit cells in the embodiments of the present disclosure. Additionally, power consumption of each of the antennas may be controlled by the metasurface controller initiating an EMF mitigation and power saving mode or a signal enhancement mode as needed. Such power consumption adjustments and changes to beamforming by the addressable reconfigurable metasurface unit cells may be based on, for example, RSSI data and SINR data detected and received at the metasurface controller executing machine readable code instructions of the ACES module.

At block 604, the method 603 may include the metasurface controller executing machine readable code instructions of the ACES module to request and receive RSSI data from an RSSI sensor. The machine readable code instructions of the ACES module being executed by the metasurface controller may send this request to the RSSI sensor, which may be operated via one or more wireless adapters at the information handling system, as described in embodiments herein. It is appreciated that the metasurface controller, executing the machine readable program code instructions of the ACES module, may determine whether the RSSI data has exceeded a RSSI threshold indicating that the received signal strength of any given wireless communication is powerful enough, in terms of dBm, to sustain sufficient wireless communications with or from a receiver wireless device from any of the antennas operating on the wireless information handling system.

Similarly, at block 606, the method 603 includes the metasurface controller executing machine readable code instructions of the ACES module to request that an SINR sensor, such as operated via one or more wireless adapters, send the SINR data to the metasurface controller. It is appreciated that the SINR sensor may be formed within the information handling system or on the reconfigurable metasurface unit cell array. In either example embodiment, the ACES module, being executed at the metasurface controller, may send this request to SINR sensor or wireless adapter operating the SINR sensor as described. It is appreciated that the metasurface controller, executing the machine readable program code instructions of the ACES module, may determine whether the SINR data has exceeded an SINR threshold indicating that the signal to noise ratio is high enough to sustain uninterrupted wireless communication with or from receiver wireless devices at any of the antennas operating on the wireless information handling system.

At block 608, the method 603 includes the metasurface controller executing machine readable code instructions of the ACES module determining whether the RSSI dBm levels with wireless devices in the radiofrequency environment exceed an RSSI threshold dBm level. Where the RSSI dBm levels do not exceed an RSSI threshold dBm level, the method 603 may continue to block 612 as described herein. Where, however, the RSSI dBm levels do exceed an RSSI threshold dBm level, the method 603 may also determine with the metasurface controller executing machine readable code instructions of the ACES module, at block 610, whether the SINR levels are sufficient for reliable communication with wireless devices in the radiofrequency environment. As such, the metasurface controller may determine whether the SINR levels exceed a SINR threshold so that the wireless signal exceeds any noise detected within the wireless transmissions by an amount such that noise does not interfere with the radiofrequency communication signal.

At block 610, where the SINR levels are sufficiently low for reliable communication and the RSSI dBm levels exceeded the threshold dBm levels at block 608, the method 603 continues to block 614.

At block 614, the method 603 includes maintaining antenna settings and the reconfigurable metasurface unit cell array settings via the metasurface controller as well as control via the hardware processor and any wireless adapters of the information handling system in some embodiments. In other embodiments at block 614, the method 603 includes adjusting the reconfigurable metasurface unit cells of the reconfigurable metasurface unit cell array via the metasurface controller to generate null regions to reduce EMF levels of the radiofrequency signals in a direction of an anticipated location of user at the information handling system.

At this point, the method 603 may return to block 604 for continuous, periodic, transmission/reception based monitoring of changes to the RSSI levels and to block 606 to monitor for changes in SINR levels. This allows the metasurface controller to remain in a signal enhanced mode that maintains the power to the one or more antennas such that wireless transmissions may be conducted and maintains the operation of the reconfigurable metasurface unit cell array in reflecting those incident radiofrequency signals from the surrounding wireless antennas or from wireless devices in the radiofrequency environment.

Where either at block 608 the RSSI dBm levels fall below the RSSI dBm threshold level insufficient for reliable communication or at block 610 the SINR levels are not sufficient (i.e., too high) for reliable communication, the method 603 continues to block 612. At block 612, the power to the plurality of antennas associated with the reconfigurable metasurface unit cell array may be adjusted. This causes the metasurface controller of the reconfigurable metasurface unit cell array to enter an power saving and EMF mitigation mode. Power consumption of any operating or non-transmitting antennas may be reduced or eliminated such that total power consumption is lowered at the antennas and the reconfigurable metasurface unit cell array in an embodiment by the metasurface controller executing machine readable code instructions of the ACES module.

At block 616, in some embodiments, the method 603 may include the metasurface controller executing machine readable code instructions of the ACES module to determine if a total power consumption level at one or more antennas currently exceeds a power threshold level due to adjustment from RSSI levels not high enough or SINR levels too high as described. Where the power levels at one or more of the plurality of antennas of the information handling system, such as those around a perimeter of the reconfigurable metasurface unit cell array, exceed the power level threshold, the method 603 may continue to block 618. Where the power levels at the one or more plurality of antennas of the information handling system, such as those around a perimeter of the reconfigurable metasurface unit cell array, do not exceed the power level threshold, the method 603 may continue to block 620. In yet other embodiments, step 616 is not required and the method proceeds to block 618 to adjust beamforming of the reconfigurable metasurface.

At block 618, the metasurface controller activates adjustments to the addressable reconfigurable metasurface unit cell array to increase wireless transmission through beamforming of reflected EM waves of a radiofrequency signal. This may be done according various embodiments described herein. For example, the metasurface controller executing the machine readable code instructions of the ACES module and a metasurface control module makes adjustments to conductivity of one or more resonant structures, such as concentric rings, to alter phase shifting of reflected EM waves in the addressable reconfigurable metasurface unit cells of the reconfigurable metasurface unit cell array in an embodiment. In other embodiments, the metasurface controller executing the machine readable code instructions of the ACES module and a metasurface control module makes adjustments via operation of a varactor or variable capacitor in a tunable delay circuit of the addressable reconfigurable metasurface unit cells of the reconfigurable metasurface unit cell array.

In further embodiments, where it is deemed necessary to reduce EMF exposure of users of a wireless information handling system, the metasurface controller executing the machine readable code instructions of the ACES module and a metasurface control module makes adjustments to conductivity of one or more resonant structures or tunable delay circuit of the addressable reconfigurable metasurface unit cells of the reconfigurable metasurface unit cell array to create a null region in a direction where the user is subjected to reduced EMFs, such as in front of a display screen of a laptop type information handling system.

Where, at block 616, the total power consumption does not exceed the power threshold level (e.g., a power consumption associated with a power conservation mode at the information handling system), the method 603 proceeds to block 620. At block 620, the ACES module may maintain antenna power settings and the reconfigurable metasurface unit cell array settings via the metasurface controller as well as control via the hardware processor and any wireless adapters of the information handling system in some embodiments. In other embodiments at block 620, the method 603 includes adjusting the reconfigurable metasurface unit cells of the reconfigurable metasurface unit cell array via the metasurface controller to generate null regions to reduce EMF levels of the radiofrequency signals in a direction of an anticipated location of user at the information handling system.

At block 622, the method 603 may include determining whether the RSSI data or the SINR data has changed. Where it has, the method may return to block 604 to continue to monitor for changes in the RSSI data at block 604 and/or SINR data at block 606 as described herein. Where the RSSI data or SINR data has not changed, the method 603 continues to bock 624.

At block 624, the method 603 includes determining if the reconfigurable metasurface unit cell array and information handling system are still initiated. Where the reconfigurable metasurface unit cell array and information handling system are still initiated, the method 603 proceeds to block 604 with the information handling system continuing to monitor for changes in the RSSI data at block 604 and/or SINR data at block 606 as described herein. Where the reconfigurable metasurface unit cell array and information handling system are no longer initiated, the method 603 may end here.

The processes or steps and aspects of the operation of the embodiments herein, such as in FIGS. 5 and 6, or others discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor, a memory device, a wireless interface adapter, and a power management unit (PMU) to provide power to the hardware processor, the memory device, and the wireless interface adapter to transceive wireless network data with a target wireless device in a radiofrequency environment;
a reconfigurable metasurface unit cell array operatively coupled to a chassis surface of the information handling system to manipulate electromagnetic (EM) waves of incident radiofrequency signals transmitted or received by plural radiofrequency (RF) antennas on the information handling system, wherein the reconfigurable metasurface unit cell array includes a plurality of reconfigurable metasurface unit cells and each reconfigurable metasurface unit cell includes a set of resonant structures formed into concentric resonant structures with one or more of the concentric structures made of a phase change material that, when heated by a refractory heater, switches between conductive material phase and a dielectric material phase to adjust reflection of the incident radiofrequency signal;
a metasurface controller to execute machine readable program code instructions of an adaptive communications enhancement system (ACES) module to determine when the radiofrequency signal falls below a sufficient radiofrequency signal communication threshold based on received signal strength indicator (RSSI) data from an RSSI sensor falling below an RSSI threshold level or a signal-to-interference-plus-noise ratio (SINR) data level from an SINR sensor falling below an SINR threshold level; and
the metasurface controller to execute machine readable program code instructions of an adaptive communications enhancement system (ACES) module to adjust, based on whether the radiofrequency signal falls below the RSSI threshold level or the SINR threshold level, power to any of the plurality of RF antennas and to adjust the reconfigurable metasurface unit cell array to beamform the radiofrequency signal to dynamically increase RSSI levels of the radiofrequency signal with the target wireless device in the radiofrequency environment.

2. The information handling system of claim 1, wherein the chassis surface is a display chassis lid cover of the information handling system.

3. The information handling system of claim 1, wherein the plurality of RF antennas are formed around a perimeter of the reconfigurable metasurface unit cell array.

4. The information handling system of claim 1 further comprising:
the concentric resonant structures of the reconfigurable metasurface unit cells are concentric ring structures and include a metal fixed tab formed within the concentric ring structures.

5. The information handling system of claim 1 further comprising:
the metasurface controller to execute machine readable program code instructions of the ACES module to determine when the RSSI data of the radiofrequency signal from the RSSI sensor meets the RSSI threshold level and the SINR data level from the SINR sensor meets the SINR threshold level; and
the metasurface controller to execute machine readable program code instructions of the ACES module to maintain the power level to the plurality of RF antennas and to maintain configuration of the reconfigurable metasurface unit cell array.

6. The information handling system of claim 1 further comprising:
the metasurface controller to execute machine readable program code instructions of the ACES module to determine when the RSSI data of the radiofrequency signal from the RSSI sensor meets the RSSI threshold level and the SINR data level from the SINR sensor meets the SINR threshold level; and
the metasurface controller to execute machine readable program code instructions of the ACES module to send a bias voltage to the tunable delay circuit to phase shift the captured, incident radiofrequency signal to generate interference patterns in the reflected radiofrequency signal to create a null region within the EM waves of the incident radiofrequency signal on one side of the information handling system.

7. The information handling system of claim 1 further comprising:
each reconfigurable metasurface unit cell including a plurality of contact pads to operatively couple a first refractory heater and a second refractory heater to a metasurface power source controlled by the metasurface controller to provide power to the first refractory heater and the second refractory heater to provide a heat pulse to the one or more of the concentric resonant structures made of the phase change material to switch between the conductive material phase and the dielectric material phase to adjust reflection of the incident radiofrequency signal.

8. A method of adaptively enhancing a communication system at a reconfigurable metasurface unit cell array with a plurality of radiofrequency (RF) antennas formed on an information handling system, comprising:
receiving and reflecting a radiofrequency signal at the reconfigurable metasurface unit cell array including a plurality of reconfigurable metasurface unit cells formed with a set of concentric resonant structures having one or more phase change material resonant structures of the concentric resonant structures made of a phase change material that, when heated by a refractory heater, switches between conductive material phase to a dielectric material phase to adjust reflection of the reflected radiofrequency signal;
executing machine readable program code instructions of an adaptive communications enhancement system (ACES) module, via a metasurface controller, to determine when a radiofrequency signal detected at the reconfigurable metasurface unit cell array falls below a sufficient radiofrequency signal communication threshold based on received signal strength indicator (RSSI) data from an RSSI sensor falling below an RSSI threshold level or a signal-to-interference-plus-noise ratio (SINR) data level from an SINR sensor falling below an SINR threshold level; and
executing machine readable program code instructions of an adaptive communications enhancement system (ACES) module, via the metasurface controller, to adjust, based on whether the radiofrequency signal falls below the RSSI threshold level or the SINR threshold level, power to at least one of the plurality of RF antennas and to adjust the reconfigurable metasurface unit cell array to beamform the reflected radiofrequency signal to dynamically increase RSSI levels of the radiofrequency signal with a target wireless device in a radiofrequency environment.

9. The method of claim 8, wherein the reconfigurable metasurface unit cell array is formed onto a surface of a display chassis lid cover of the information handling system.

10. The method of claim 8 further comprising:
adjusting each reconfigurable metasurface unit cell with power supplied to contact pads to operatively couple either a refractory heater to a metasurface power source controlled by the metasurface controller to provide power to the first refractory heater to provide a heat pulse to the at least one of the phase change material concentric resonant structures made of the phase change material to adjust a phase shift of the reflected radiofrequency signal at the reconfigurable metasurface unit cell.

11. The method of claim 8, wherein the phase-changing material of the one or more phase change material concentric resonant structures is selected from germanium telluride (GeTe), antimony telluride (SbTe), or chalcogenide (GeSbTe) that selectively switch between the conductive material phase and the dielectric material phase when heat is applied.

12. The method of claim 8 further comprising:
executing machine readable program code instructions of the ACES module via the metasurface controller, to determine when the RSSI data of the radiofrequency signal from the RSSI sensor meets the RSSI threshold level and the SINR data level from the SINR sensor meets the SINR threshold level; and
the metasurface controller to execute machine readable program code instructions of the ACES module to maintain the power level to the plurality of RF antennas and to maintain configuration of the reconfigurable metasurface unit cell array.

13. An information handling system comprising:
a hardware processor, a memory device, a wireless interface adapter, and a power management unit (PMU) to provide power to the hardware processor, memory device, and wireless interface adapter to transceive wireless network data with a target wireless device in a radiofrequency environment;
a reconfigurable metasurface unit cell array operatively coupled to a chassis surface of the information handling system to manipulate electromagnetic (EM) waves of incident radiofrequency signals transmitted or received by plural radiofrequency (RF) antennas on the information handling system, the reconfigurable metasurface unit cell array including a plurality of reconfigurable metasurface unit cells where each reconfigurable metasurface unit cell includes a set of resonant structures to receive the incident radiofrequency signal;
a microwave circuit with a tunable delay circuit coupled to the set of resonant structures, wherein the microwave circuit is configured to capture the incident radiofrequency signals from the resonant structures and perform phase shift of the captured, incident radiofrequency signals with the tunable delay circuit controlled by a metasurface controller;
a metasurface controller to execute machine readable program code instructions of an adaptive communications enhancement system (ACES) module to determine when the radiofrequency signal falls below a sufficient radiofrequency signal communication threshold based on received signal strength indicator (RSSI) data from an RSSI sensor falling below an RSSI threshold level or a signal-to-interference-plus-noise ratio (SINR) data level from an SINR sensor falling below an SINR threshold level; and
the metasurface controller to execute machine readable program code instructions of an adaptive communications enhancement system (ACES) module to adjust, based on whether the radiofrequency signal falls below the RSSI threshold level or the SINR threshold level, power to at least one of the plurality of RF antennas and to adjust the reconfigurable metasurface unit cell array to beamform the radiofrequency signal to dynamically increase RSSI levels of the radiofrequency signal with the target wireless device in the radiofrequency environment.

14. The information handling system of claim 13, wherein the chassis surface is a display chassis lid cover of the information handling system.

15. The information handling system of claim 13 further comprising:
the metasurface controller to send a bias voltage to an attenuator circuit to adjust the amplitude of the reflected radiofrequency signal at a first metasurface unit cell to adjust a level of constructive interference to the incident radiofrequency signal created by phase adjustment operation of the tunable delay circuit.

16. The information handling system of claim 13 further comprising:
the metasurface controller to send a bias voltage to the tunable delay circuit to phase shift the captured, incident radiofrequency signal to generate interference patterns for a reflected radiofrequency signal in phase among the plurality of reconfigurable metasurface unit cells to beamform radiofrequency transmission or reception lobes and increase gain of the reflected EM waves of the incident radiofrequency signal.

17. The information handling system of claim 13, wherein the plurality of RF antennas are formed around a perimeter of the reconfigurable metasurface unit cell array.

18. The information handling system of claim 13 further comprising:
the resonant structures of the reconfigurable metasurface unit cells include a metal fixed tab formed within the passive set of concentric antennas structures.

19. The information handling system of claim 13 further comprising:
the metasurface controller to execute machine readable program code instructions of the ACES module to determine when the RSSI data of the radiofrequency signal from the RSSI sensor meets the RSSI threshold level and the SINR data level from the SINR sensor meets the SINR threshold level; and
the metasurface controller to execute machine readable program code instructions of the ACES module to maintain the power level to the plurality of RF antennas and to maintain configuration of the reconfigurable metasurface unit cell array.

20. The information handling system of claim 19 further comprising:
the metasurface controller to execute machine readable program code instructions of the ACES module to determine when the RSSI data of the radiofrequency signal from the RSSI sensor meets the RSSI threshold level and the SINR data level from the SINR sensor meets the SINR threshold level; and
the metasurface controller to execute machine readable program code instructions of the ACES module to send a bias voltage to the tunable delay circuit to phase shift the captured, incident radiofrequency signal to generate interference patterns in the reflected radiofrequency signal to create a null region within the EM waves of the incident radiofrequency signal on one side of the information handling system.
